(19) United States
(12) Patent Application Publication
(10) Pub. No.: US 2026/0046794 A1
(43) Pub. Date: Feb. 12, 2026

(54) MECHANISM AND METHOD FOR SYNCHRONIZING COMMUNICATING DEVICES VIA BLUETOOTH LOW ENERGY WIRELESS LINKS

(71) Applicant: MIHAI SIMA, VICTORIA (CA)

(72) Inventor: MIHAI SIMA, VICTORIA (CA)

(21) Appl. No.: 19/287,499

(22) Filed: Jul. 31, 2025

Related U.S. Application Data
(60) Provisional application No. 63/681,861, filed on Aug. 11, 2024.

(51) Int. Cl. H04W 56/00; H04L 7/00

(52) U.S. Cl. CPC H04W 56/001; H04L 7/0033; H04W 56/0035; H04W 56/004

(57) ABSTRACT

Mechanism and method are disclosed for the synchronization of communicating devices via Bluetooth Low Energy (BLE) wireless links. Specifically, the invention pertains to synchronizing an Internet-of-Things (IoT) peripheral device, which includes hardware additions for performing timestamping at the BLE physical layer, to a mobile device, such as a smartphone or tablet, that executes the BLE protocol in software, By equalizing the processing time of the transmitted data to the BLE connection interval, accurate synchronization can be achieved without the need for timestamping at the BLE physical layer on the mobile device, This disclosure addresses a longstanding challenge in synchronization over BE wireless links, which has persisted in the industry since the introduction of the BLE wireless communication protocol.

This application claims the benefit under 35 U.S.C. § 119(e) of U.S. Provisional Patent Application No. 63/681,861, filed Aug. 11, 2024, which is hereby incorporated by reference in its entirety. In this disclosure, specific embodiments of the invention are described with reference to the accompanying figures. For consistency, like elements in the figures are denoted by like reference numerals. In the following description, numerous specific details are set forth to provide a thorough understanding of the invention. However, it will be apparent to those skilled in the art that the invention may be practiced without these specific details. In other instances, well-known features have not been described in detail so as not to obscure the invention.

### FIELD OF THE INVENTION

The present invention generally relates to the synchronization of Communicating Devices via wireless links. More specifically, as illustrated in FIG. 1, the present invention pertains to synchronizing a first communicating device, also referred to as a Client Device 101, to a second communicating device, also referred to as a Time Server 104, via a Bluetooth Low Energy (BLE) Wireless Link 105. As shown in FIG. 2, the first communicating device may be an Internet-of-Things (IoT) Peripheral 201 incorporating a BLE module 102, while the second communicating device may be a Mobile Device 202 acting as a time server, such as a smartphone or a tablet, also incorporating a ELE module 106, such that both communicating devices support the BLE communication protocol, A block diagram of the layered implementation of the BLE communication protocol. known as the BLE Stack 300. is presented in FIG. 3.

### Glossary

Base Station is a radio transceiver that serves as the central hub of a wireless network,
Bluetooth Low Energy (BLE) is a wireless communication protocol primarily designed for consumer electronics powered by small batteries,
Bluetooth Low Energy standard is a document maintained and approved by the Bluetooth Special Interest Group (SIG) that outlines the requirements, specifications, guidelines, and characteristics necessary for building Bluetooth Low Energy peripherals.
Bluetooth Special Interest Group (SIG) is a consortium of member organizations that serve as the caretakers and innovators of Bluetooth© technology.
Backward Transmission refers to the process of sending data from a time server back to a client device.
BLE Connection Event is a data transfer period during which the BLE radio circuit is ON.
BLE Connection Interval is the time between two consecutive BLE connection events.
BLE Device is a communicating device equipped with a BLE module.
BLE Module is a functional component that implements the BLE communication protocol.
BLE Stack is a layered group of hardware, firmware, and software components that implement the BLE communication protocol,
Client Device is a communicating device whose system time is offset relative to the system time of a time server.
Communicating Device is a computer system connected to a network, capable of sending and receiving data over that network.
Central Processing Unit (CPU) is the primary component of a computer that processes instructions from programs.
Data Packet is a message in the form of a small, structured unit of data transmitted over a network.
Ethernet is a family of wired networking technologies used in local area networks.
Forward Transmission refers to the process of sending data from a client device to a time server.
Internet of Things (toT) refers to a network of physical objects (“things”) that are embedded with sensors for exchanging data with other devices and systems over the Internet.
Internet of Things Device (IoT Device) is a device that is part of the Internet of Things.
Long-Range Bluetooth Low Energy (LR:BLE) is a mode of the BLF protocol designed for long-range communications, supporting error correction coding and lower data rate than the standard BLE protocol,
Media Access Control (MAC) is a communication protocol layer that controls the hardware responsible for interacting with the transmission medium.
Mobile Device is a portable electronic device, such as a laptop, tablet, or smartphone, that can connect to a wireless network.
Network Time Protocol (NTP) is an Internet protocol used to synchronize the system clocks of computer systems over a network.
NTP Server is a specialized computer that provides accurate time information to other devices on a network using the Network Time Protocol (NTP).
Open Systems Interconnection (OSI) model is a conceptual framework that organizes network communication functions into seven layers.
Peripheral is an external device that a computer uses to exchange data with the outside world.
Router is a specialized computer that forwards data packets to the appropriate segments of a computer network.
System Clock provides an accurate time-of-day function, which returns the system time of a computer system through integrated hardware, firmware, and software components.
System Clock Synchronization is the process of adjusting the system clocks of computer systems so that they provide the same system time.
System Time refers to the current time of day maintained within a computer system, allowing applications running on it to access and utilize the time as needed.
Time Offset is the difference between the system times of two communicating devices.
Time-Ordered Set is a collection of elements arranged according to their acquisition time.
Time Server is a communicating device whose system time is regarded as accurate and is used as a reference for time synchronization.
Timestamp is a recorded sample of the system time captured at a specific point in time.
Timestamping is the process of capturing one or more samples of the system time at specific points in time.
Wi-Fi is a wireless networking technology used to create local area networks, based on the IEEE 802.11 family of standards,

### Acronyms

AC . . . Alternating Current
AL . . . Application Layer (of the Bluetooth Low Energy stack)
BLE . . . Bluetooth Low Energy
CI . . . Connection Interval (of the Bluetooth Low Energy protocol)
CPU . . . Central Processing Unit
DC . . . Direct Current
FIFO . . . First-In First-Out (stack)
FTSP . . . Flooding Time Synchronization Protocol
HCl . . . Host-Controller Interface (of the Bluetooth Low Energy stack)
HSP . . . I-lost Stack & Profiles (of the Bluetooth Low Energy stack)
IoT . . . Internet-of-Things
LL . . . Link Layer (of the Bluetooth Low Energy stack)
LRBLE . . . Long-Range Bluetooth Low Energy
MAC . . . Media Access Control
NOP . . . No-OPeration (instruction of a processor)
NTP . . . Network Time Protocol
OP . . . OPeration (executed by a processor)
OSI . . . Open Systems Interconnection
PY . . . PHYsical layer (of the Bluetooth Low Energy stack)
PTP . . . Precision Time Protocol
RBS . . . Reference Broadcast Synchronization (protocol)
RFPHY . . . Radio-Frequency PHYsical layer (of the Bluetooth Low Energy stack)
R-Packet . . . Received Data Packet
RTOS . . . Real-Time Operating System
SIG . . . (Bluetooth) Special Interest Group
T-Packet . . . Transmitted Data Packet
TPSN . . . Timing-sync Protocol for Sensor Networks
WPTP . . . Wireless Precision Time Protocol

### Notations

δ . . . Roundtrip Message Propagation Delay
δ_{F} . . . Forward (from Client Device to Time Server) Message Propagation Delay
δ_{B} . . . Backward (from Time Server to Client Device) Message Propagation Delay
δ_{OV} . . . Overhead Delay (due to the Operating System)
δ_{FOV} . . . Total Forward (from Client Device to Time Server) Message Delay
δ_{BOV} . . . Total Backward (from Time Server to Client Device) Message Delay
ε . . . System clock synchronization error
θ . . . Time offset (or timeshift) between a Client Device and a Time Server
θ . . . An estimate of the time offset obtained through measurements
τ . . . Time delay or latency
τ_{D,AL+HSP} . . . Latency of AL+HSP routines running on client Device
Σ_{D,AL+HSP,F} . . . Latency of AL-,+HSP routines running on client Device during Forward transmission
τ_{D,AL+HSP,B} . . . Latency of AL+HSP routines running on client Device during Backward transmission
τ_{D,LL} . . . Latency of LIL routines running on client Device
τ_{D,LL,F} . . . Latency of LL routines running on client Device during Forward transmission
τ_{D,LL,B} . . . Latency of LL routines running on client Device during Backward transmission
τ_{D,PHY} . . . Latency of client Device's PHY hardware/firmware
τ_{D,PHY,F} . . . Latency of client Device's PHY hardware/firmware during Forward transmission
τ_{D,PHY,B} . . . Latency of client Device's PHY hardware/firmware during Backward transmission
τ_{PROP} . . . Electromagnetic wave PROPagation time,
τ_{PROP,F} . . . Electromagnetic wave PROPagation time in Forward direction.
τ_{PROP,B} . . . Electromagnetic wave PROPagation time in Backward direction.
τ_{S,AL+HSP} . . . Latency of AL+HSP routines running on time Server
τ_{S,AL+HSP,F} . . . Latency of AL±HSP routines running on time Server during Forward transmission
τ_{S,AL+HSP,B} . . . Latency of AL+HSP routines running on time Server during Backward transmission
τ_{S,LL} . . . Latency of LL routines running on time Server
τ_{S,LL,F} . . . Latency of LL routines running on time Server during Forward transmission
τ_{S,LL,B} . . . Latency of LL routines running on time Server during Backward transmission
τ_{S,PHY} . . . Latency of time Server's PHY hardware/firmware
τ_{S,PHY,F} . . . Latency of time Server's PHY hardware/firmware during Forward transmission
τ_{S,PHY,B} . . . Latency of time Server's PHY hardware/firmware during Backward transmission
I_{supply} . . . Total supply current of a BLE device
i_{supply} . . . AC component of the total supply current of a BLE device
I_{SUPPLY} . . . DC component of the total supply current of a BLE device
T_{CI} . . . Duration of the BLE Connection Interval
T_{CI,min} . . . Shortest duration of the BLE Connection interval that matches the total message delay
T_{1, device} . . . First sample of the System Time (First Timestamp), acquired on Client Device
T_{2,server} . . . Second sample of the System Time (Second Timestamp), acquired on Time Server
T_{3,server} . . . Third sample of the System Time (Third Timestamp), acquired on Time Server
T_{4,device} . . . Fourth sample of the System Time (Fourth Timestamp), acquired on Client Device
V_{Supply} . . . Total voltage drop across a shunt resistor
ν_{supply} . . . AC component of the total voltage drop across a shunt resistor
V_{SUPPLY} . . . DC component of the total voltage drop across a shunt resistor

### BRIEF DESCRIPTION OF THE DRAWINGS

The description of the invention makes reference to the accompanying drawings, in which:

FIG. 1 illustrates a client device connected to a time server via a Bluetooth Low Energy (BLE) wireless link;

FIG. 2 illustrates an Internet-of-Things (IoT) peripheral connected to a mobile device acting as a time server, such as a smartphone or tablet, via a Bluetooth Low Energy (BLE) wireless link;

FIG. 3 illustrates the block diagram of the Bluetooth Low Energy (BLE) stack;

FIG. 4 illustrates the system clock synchronization process using the Network Time Protocol (NTP);

FIG. 5 illustrates commonly accepted error factors in system clock synchronization via BLE wireless links;

FIG. 6 illustrates timestamping at the beginning (T_{1,device}) and at the end (T_{2,server}) of processing at the BLE application layer during forward transmission;

FIG. 7 illustrates the Gradient Clock Synchronization method using random timestamping at the MAC layer;

FIG. 8 illustrates an attempt in the Prior Art to estimate network bandwidth;

FIG. 9 illustrates a shunt monitor, Rₛₕᵤₙₜ, connected in series with the supply pin, V_{SUPPLY}, of a Bluetooth Low Energy (BLE) module;

FIG. 10 illustrates the waveform of the shunt voltage drop, ¹shunt, across the shunt monitor, Rₛₕᵤₙₜ;

FIG. 11 illustrates an IoT peripheral, equipped with hardware additions for performing timestamping at the physical layer, connected via a Bluetooth Low Energy (BLE) wireless link to a mobile device, such as a smartphone or a tablet, acting as a time server.

FIG. 12 illustrates an improved circuit with a shunt monitor, Rₛₕᵤₙₜ, connected in series with the supply pin, V_{supply}, of a Bluetooth Low Energy (BLE) module, enabling timestamping at the BLE physical layer;

FIG. 13 illustrates current consumption over time during a BLE connection;

FIG. 14 illustrates current consumption over time during a single EL. connection event;

FIG. 15 illustrates the supply current profile during a BLE connection event involving two connected nRF5i 1822 BLE SoC devices;

FIG. 16 illustrates timestamping at the beginning (T_{1,device}) and at the end (T_{2,server}) of processing at the BLE physical layer during forward transmission;

FIG. 117 illustrates timestamping at the end of processing at the BLE physical layer (T_{1,device}) and application layer (T_{1,server}) during forward transmission;

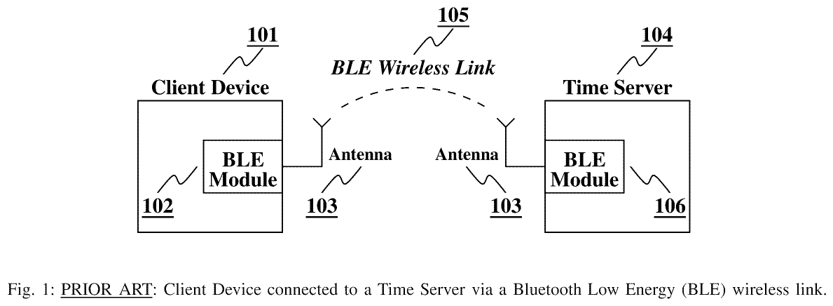

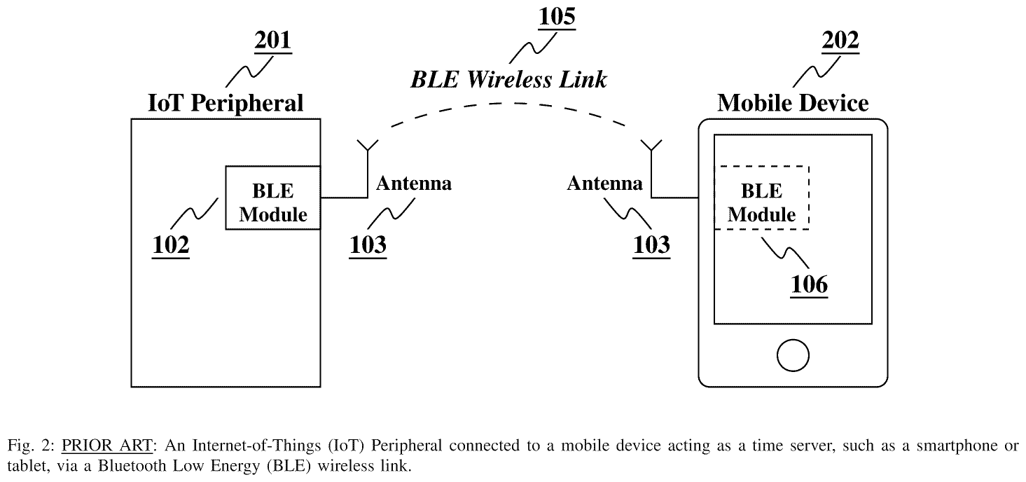

FIG. 18 presents the flowchart for matching the ELF connection interval duration, T_{CI}, with the total forward message delay, δ_{FOV};

FIG. 19 illustrates a train of packets sent in the forward direction over a BLE link, where the connection interval period, T_{CI}, equals the total message processing (i.e., decoding) delay at the receiver, δ_{FOV}-δ_{PROP};

FIG. 20 illustrates a train of packets sent in the forward direction over a BLE link with negligible propagation delay, τ_{PROP}, where the connection interval period, T_{CI}, equals the total forward message delay, δ_{FOV},

### REFERENCE NUMERALS

101 . . . Client Device
102 . . . BLE Module incorporated into a general Client Device, or a specific IoT Peripheral
103 . . . A n ten n a
104 . . . Time Server
105 . . . BLE Wireless Link
106 . . . BLE Module incorporated into a general Time Server, or a specific Mobile Device
201 . . . IoT Peripheral
202 . . . Mobile Device
300 . . . Bluetooth Low Energy Stack
301 . . . Application Layer (of the BLE stack)
302 . . . Host Stack & Profiles layer (of the BLE stack)
303 . . . Host-Controller Interface layer (of the, BLE stack)
304 . . . Link Layer (of the BLE stack)
305 . . . Physical Layer (of the BLE stack)
306 . . . BLE Host Central Processing Unit (CPU)
307 . . . BLE Controller
400 . . . System Clock Synchronization Process using the Network Time Protocol (NTP)
401 . . . ,Client Computer
402 . . . Router 1
403 . . . Router N
404 . . . NTP Server
405 . . . First Timestamp, T_{1,device}
406 . . . Second Timestamp, T_{2,server}
407 . . . Third Timestamp, T_{3,server}
408 . . . Fourth Timestamp, T_{4,device}
409 . . . NTP Message
501 . . . Send Time
502 . . . Access Time at the Transmitter
503 . . . Transmission Time
504 . . . Propagation Time
505 . . . Reception Time
506 . . . Access Time at the Receiver
507 . . . Receive Time
508 . . . Forward Transmission
509 . . . Backward Transmission
601 . . . Forward Message Propagation Delay with timestamping at the beginning and end of the application layer code
602 . . . Transmitted Data Packet (I—Packet)
603 . . . Received Data Packet (R-Packet)
701 . . . Byte String
702 . . . Period of the Transmitted Byte String
800 . . . Forward Propagation of Data Packets #1 and #2
801 . . . Backward Propagation of Data Packets #1 and #2
802 . . . Wide. Bandwidth Section of a Network
803 . . . Narrow-Bandwidth Section of a Network
804 . . . Data Packet #1
805 . . . Data Packet #2
900 . . . Circuit Proposed in Academic Research Sensing the Supply Current of a BLE Device
901 . . . Clock Signal for the Clock Counter
902 . . . Clock Counter Generating the System Time of the BLE Device
903 . . . Oscillator Providing the Clock Signal for the Clock Counter
904 . . . Battery providing the Supply Voltage for the BLE Device
905 . . . Shunt Resistor, Rₛₕᵤₙₜ
906 . . . System Time Generated by the Clock Counter
907 . . . Total Supply Current of the BLE device, I_{supply}
908 . . . DC Component of the Total Supply Current, I_{SUPPLY}
909 . . . AC Component of the Total Supply Current, i_{supply}
910 . . . Total Voltage Drop Across a Shunt Resistor, V_{supply}
911 . . . DC Component of the Total Voltage Drop Across a Shunt Resistor, V_{SUPPLY}
912 . . . AC Component of the Total Voltage Drop Across a Shunt Resistor, ν_{supply}
913 . . . System Clock (of a computer system)
1001 . . . The Waveform of the Shunt Voltage drop across the Shunt Resistor
1002 . . . The Moment when the BII Radio Turns ON
1100 . . . The Architecture of the System Proposed in this Disclosure
1101 . . . Hardware Additions to a BLE module
1201 . . . Differential Voltage Amplifier
1202 . . . FIFO Stack
1203 . . . D-Type Register
1204 . . . The Bus Carrying the System Time to the FIFO Stack
1205 . . . The Bus Carrying the FIFO Stack Values to the BLE Device
1601 . . . Forward Message Propagation Delay with timestamping at the beginning and end of the physical layer
1701 . . . Forward Message Propagation Delay with timestamping at the physical and application layers
1800 . . . Flowchart for Matching the BLE Connection Interval to Total Message Propagation Delay
1801 . . . START Phase
1802 . . . Set Transmission Power Phase
1803 . . . Set Bit Pattern Phase
1804 . . . Set the BLE Connection Interval to Its Maximum Value Phase
1805 . . . Check Whether the BLE Connection Interval Is Small Enough Phase
1806 . . . Decrement the BLE Connection Interval Phase
1807 . . . Increment the BLE Connection Interval Phase
1808 . . . Increment the Total Message Propagation Delay Phase
1809 . . . Check Whether the Total Message Propagation Delay is Large Enough Phase
1810 . . . Digital Filtering Phase
1811 . . . END Phase
1812 . . . Course Tuning Phase
1813 . . . Fine Tuning Phase
1814 . . . Perform Timestamping Phase
1901 . . . BLE Connection Interval
1902 . . . Total Processing Delay at the Receiver
1903 . . . First Timestamp in a Time-Ordered Set of Timestamps at the Transmitter
1904 . . . Second Timestamp in a Time-Ordered Set of Timestamps at the Transmitter
1905 . . . Third Timestamp in a Time-Ordered Set of Timestamps at the Transmitter
1906 . . . First Timestamp in a Time-Ordered Set of Timestamps at the Receiver
1907 . . . Second Timestamp in a Time-Ordered Set of Timestamps at the Receiver
1908 . . . Third Timestamp in a Time—Ordered Set of Timestamps at the Receiver
1909 . . . First Transmitted Data Packet (T-Packet)
1910 . . . Second Transmitted Data Packet CT-Packet)
1911 . . . Third Transmitted Data Packet (T-Packet)
1912 . . . First Received Data Packet (R-Packet)
1913 . . . Second Received Data Packet (R-Packet)
1914 . . . Third Received Data Packet (R-Packet)
2001 . . . First Timestamp in a Time-Ordered Set of Timestamps at the Receiver when the Propagation Delay is Small
2002 . . . Second Timestamp in a Time-Ordered Set of Timestamps at the Receiver when the Propagation Delay is Small
2003 . . . Total Processing Delay at the Receiver when the Propagation Delay is Small

### Background of the Invention

With the recent proliferation of wireless communicating devices, such as laptops, tablets, smartphones, and Internet-of-Things (IoT) sensors, there is an increasing demand for a common notion of time among such communicating devices connected to a local wireless network. Each communicating device has its own System Clock, which is a group of hardware, firmware, and software components that collectively provide a local time-of-day function returning the System Time of the device. The ability to accurately synchronize the system clocks of a plurality of interconnected communicating devices enables distributed data logging and processing applications that would otherwise be infeasible without a uniform system time across the wireless network (see Sundararaman, Buy, Kshemkalyani, “Clock Synchronization for Wireless Sensor Networks: A Survey”).

Consider two interconnected communicating devices. The synchronization of their system clocks may be achieved through the exchange of messages, whereby one communicating device estimates the system time of the other. Once the time difference between the system times of the two communicating devices, denoted as 0, is determined, appropriate corrections can be applied to align the system clocks so that they operate in synchrony. However, it is recognized that synchronizing system clocks is a non-trivial task, owing to the high variability of message propagation delays, Therefore, a key objective of any synchronization protocol should be to mitigate the impact of message propagation delays on the accuracy of the synchronization.

Many system clock synchronization techniques have been proposed, in which a first communicating device, commonly a time server, sends a message containing the current value of its system time to a second communicating device, commonly a client device, which then adjusts its system clock based on the received system time value. This very simple one-way message technique is sufficient when the message propagation delay is small relative to the required synchronization accuracy. An extension of this approach, known as two-way message exchange, seeks to mitigate the impact of larger message propagation delay. In this technique, the client device first sends a request message to the time server, which then replies with a response message. By measuring the total round-trip delay, it becomes possible to estimate the one-way message propagation delays, as described below.

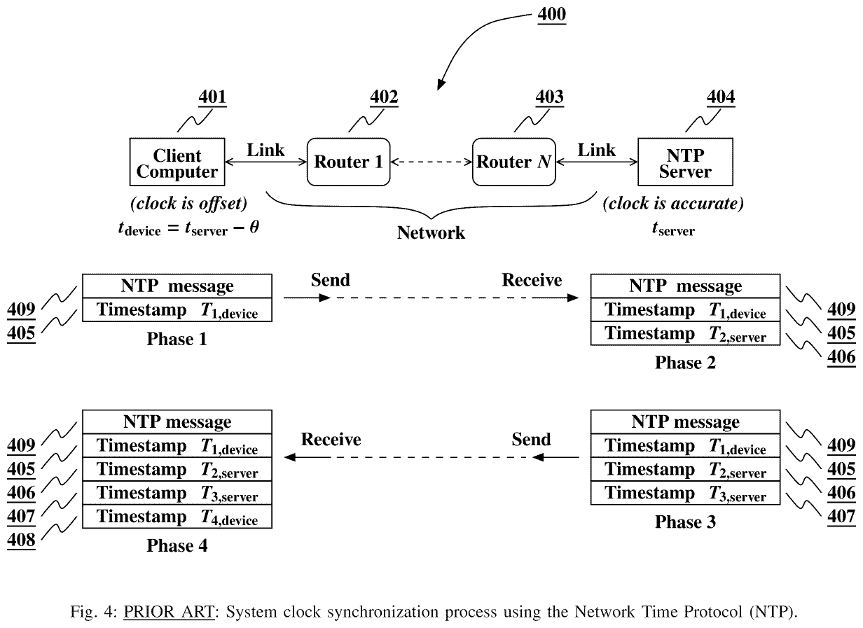

The Network Time Protocol (NTP), developed by the late Professor David L. Mills of the University of Delaware (see David L. Mills, “Network Time Protocol Version 4-Reference and Implementation Guide”) for wired networks in the early 1980s, is now an established two-way message exchange protocol used for system clock synchronization between computers connected to Internet (see David L. Mills, “Computer Network Time Synchronization—The Network Time Protocol on Earth and in Space”). The concepts of the NTP system clock synchronization 400 are presented in FIG. 4, where a Client Computer 401, whose system time is offset by an amount 0, is to be synchronized to an NTP Server 404, whose system time is considered to be accurate. The client computer 401 is connected to the NTP server 404 via a plurality of Routers 402 and 403, in a multi-hop network topology, There are five phases in the NTP synchronization process, as follows.

Phase 1: The client computer 401 initially creates an NTP message 409, which is to be sent to the NTP server 404. A first timestamp 405, denoted as T_{1,device}, is generated by sampling the client computer's system time. This timestamp is then added to the NTP message 409 when it leaves the client computer 401.

Phase 2: When the NTP message 409 arrives at the NTP server 404. a second timestamp 406, denoted as T_{2,server}, is generated by sampling the NTP server's system time. This timestamps is then added to the NTP message 409, Phase 3: The NTP server 404 sends the NTP message 409 back to the client computer 401. A third timestamp 407. denoted as T_{3,server}, is generated by sampling the NTP server's system time again. This timestamp is then added to the NTP message 409 when it leaves the NTP server 404.

Phase 4: When the client computer 401 receives the NTP message 409, a fourth timestamp 408, denoted as T_{4,device}, is generated by sampling the client computer's system time again. This timestamp is then added to the NTP message 409.

Phase 5: The first timestamp 405, T_{1,device}, the second timestamp 406, T_{2,server}, the third timestamp 407. T_{3,server}, and the fourth timestamp 408, T_{4,device}, are used to complete the system clock synchronization process, Specifically, the time offset between the client computer's system time and the NTP server's system time, denoted as θ, is estimated. Additionally, the roundtrip message propagation delay,

$$δ = {δ}_{F} + {δ}_{B} , \qquad ( 1 )$$

is accurately determined, where δ_{F} and δ_{B} represent the forward and backward message propagation delays, respectively.

For the forward transmission, which occurs in Phases 1 and 2 of the NTP system clock synchronization process, the client computer 401 acts as the transmitter, and the NIP server 404 acts as the receiver. The message receive time, T_{2,server}, corresponds to the message send time, T_{1,device}, adjusted by the time offset, θ, and increased by the forward message propagation delay, δ_{F}. This relationship is expressed in Equation 2.

$${T}_{2 , server} = {T}_{1 , device} + θ + {δ}_{F} \qquad ( 2 )$$

For the backward transmission, which occurs in Phases 3 and 4 of the NTP system clock synchronization process, the NTP server 404 acts as the transmitter, and the client computer 401 acts as the receiver. The message receive time, T_{4,device}, when corrected by the time offset. θ, corresponds to the message send time, T_{3,server}, increased by the backward message propagation delay, δ_{B}. This relationship is expressed in Equation 3. PGP

$${T}_{4 , device} + θ = {T}_{3 , server} + {δ}_{B} \qquad ( 3 )$$

By adding Equation 3 to Equation 2, the time offset θ is eliminated, allowing for an accurate calculation of the roundtrip message propagation delay, δ. This result is expressed in Equation 4.

$${T}_{2 , server} + ( {T}_{4 , device} + θ ) = {T}_{1 , device} + θ + {δ}_{F} + ( {T}_{3 , server} + {δ}_{B} ) ⇒ ⇒ {δ}_{F} + {δ}_{B} = δ = ( {T}_{4 , device} - {T}_{1 , device} ) - ( {T}_{3 , server} - {T}_{2 , server} ) \qquad ( 4 )$$

By subtracting Equation 3 from Equation 2, an estimate of the time offset θ. denoted as θ, can be calculated, This result is expressed in Equation 5.

$$( 5 )$$

$${T}_{2 , server} − ( {T}_{4 , devive} + θ ) = {T}_{1 , device} + θ + {δ}_{F} − ( {T}_{3 , server} + {δ}_{B} ) ⇒ ⇒ 2 θ = {T}_{2 , server} − {T}_{4 , device} − {T}_{1 , device} + {T}_{3 , server} + ( {δ}_{B} − {δ}_{F} ) ⇒ ⇒ θ = {\underbrace{\frac{( {T}_{2 , server} − {T}_{1 , device} ) + ( {T}_{3 , server} − {T}_{4 , device} )}{2}}}_{\hat{θ} = estimate} - {\underbrace{\frac{{δ}_{F} − {δ}_{B}}{2}}}_{ε = error}$$

If the forward and backward message propagation delays, δ_{F} and δ_{B}, are not equal, then the estimate of the time offset, θ, deviates from the actual time offset, θ, by an error term, ε, as shown in Equation 5. This error is challenging to quantify because there are no straightforward methods to independently measure the forward and backward message propagation delays; as indicated in Equation 4, only their sum can be accurately determined. In the ideal case, where the forward and backward propagation delays are equal, the estimated time offset, θ, matches the actual time offset, θ, as expressed in Equation 6.

$${δ}_{F} = {δ}_{B} ⇒ ε = 0 ⇒ θ = \hat{θ} = \frac{( {T}_{2 , server} - {T}_{1 , device} ) + ( {T}_{3 , server} - {T}_{4 , device} )}{2} \qquad ( 6 )$$

It is generally accepted that the Network Time Protocol can maintain system clock synchronization with an error, ε, on the order of tens of milliseconds over the public Internet (see, for example, David L, Mills, “Computer Network Time Synchronization—The Network Time Protocol on Earth and in Space”; and Novick and Lombardi, “Practical Limitations of NTP Time Transfer”). However, if the forward and backward routes are highly asymmetric, then the synchronization error, ε, can exceed several hundred milliseconds. While such an error may be acceptable for home users connected to Internet, where a synchronization within one second is often sufficient, it is inadequate for industrial. scientific, or medical applications that require much tighter synchronization precision. In wired networks, the asymmetry may result from dynamic routing, as well as from variability in switching delays. These issues are often more pronounced in wireless networks due to factors such as interference and channel noise (see Mani, Durairajan, Barford, and Sommers, “MNTP: Enhancing Time Synchronization for Mobile Devices”), Consequently, the Network Time Protocol alone is insufficient for achieving accurate system clock synchronization over wireless links.

System clock synchronization is especially important in many wireless networks that incorporate IoT peripherals and mobile devices. If IoT peripherals powered by small-sized batteries are to be used, then power consumption must be minimized, which means that system clock synchronization, and data communications is general, will have to be achieved over Bluetooth Low Energy links.

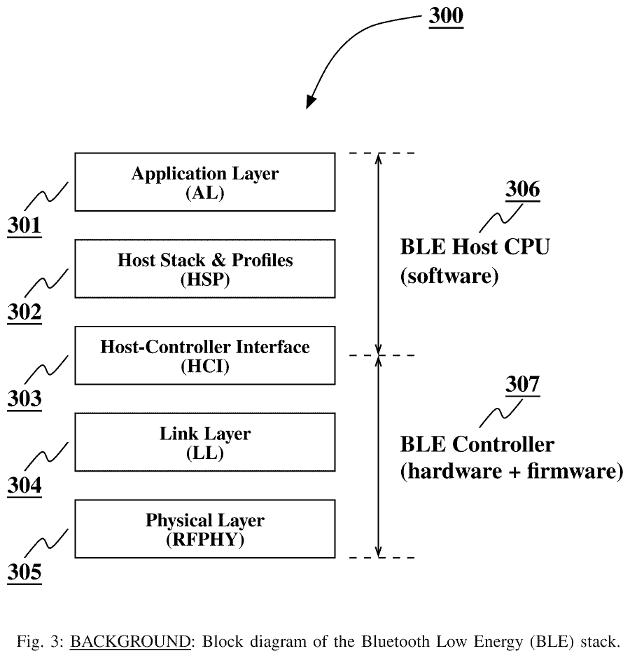

Bluetooth Low Energy (BLE) is a wireless communication protocol used for exchanging messages in the form of data packets over short distances, with very low power consumption (see “The Bluetooth Low Energy Primer,” Bluetooth Special Interest Group; M. Afaneh, “Intro to Bluetooth Low Energy: Learn Bluetooth Low Energy in a single weekend”; and R. Heydon, “Bluetooth Low Energy: The Developer's Handbook”). In particular, the BLE communication protocol can be used for Internet-of-Things (IoT) sensor data collection using ubiquitous handheld mobile devices, such as commercially available smartphones and tablets, which are carried by human operators. This scenario is illustrated in FIG. 2. The BLE communication protocol is implemented through a combination of hardware, firmware, and/or software components organized into a layered architecture. This layered set of components, which provides BLE communication services, is referred to as the BLE communication protocol stack, or simply the BLE stack 300. The BLE stack spans multiple layers of the Open Systems Interconnection (OSI) reference model (see Debbra Wetteroth, “OSI Reference Model for Telecommunications”). The BLE stack 300 is summarized in FIG. 3, where several fundamental elements can be identified, as described below.
The Radio-Frequency PHYsical (RFPHY) layer controller 305, or simply the PHYsical (PHY) layer controller, integrates an analog radio and digital logic to provide essential radio functions such as modu-lation, demodulation, and frequency control.
Link Layer (LL) controller 304, which is equivalent to a Media Access Control (MAC) layer controller found in other OSI-based wireless standards such as WiFi, Thread, and Zigbee, is responsible for scheduling the transmission and reception of data packets to and from the physical layer 305.
The Host Stack and Profiles (HSP) software 302 runs on a host Central Processing Unit (CPU) 306, which may be a microcontroller, an embedded processor, or a mobile processor. It operates alongside the Application Layer (AL) code 301, which is typically developed by a programmer. The HSP software 302 consists of multiple transport and network routines,
The interface between the HSP layer 302 and the Link Layer 304, known as the Host-Controller Interface (HCl) 303, enables seamless integration of FISP software routines with Link Layer firmware routines from different vendors.
controllers handling the Link Layer 304 and Physical Layer 305 protocols are components of the BLE Controller 307, which is typically implemented in hardware and firmware.

It should be noted that programmers typically do not have access to the low-level functions implemented within the lower layers of the BLE stack. As a result, sampling the system time, which is referred to as Timestamping in this disclosure, must be performed in software, at a high layer of the BLE stack, specifically the application layer 301. Significant variability in processing time across the application layer 301, host stack and profiles layer 302, and link layer 304 may introduce additional several hundred milliseconds to either the forward or backward message propagation delays, δ_{F} or δ_{B}. This can lead to highly asymmetric message propagation delays (see, for example, Harada, Izumi, Kozeni, Yoshikawa, Ishii, and Kawaguchi, “20-μs Accuracy Time-Synchronization Method using Bluetooth Low Energy for Internet-of-Things Sensors”; and Asgarian and Najafi, “BlueSync: Time Synchronization in Bluetooth Low Energy with Energy-Efficient Calculations”). As a result, the system clock synchronization error, ε, can become substantial.

To understand the sources of error in synchronizing system clocks via wireless links, it is useful to identify the components that contribute to message propagation delay (see Kopetz and Ochsenreiter, “Clock Synchronization in Distributed Real-Time Systems”; Kopetz and Schwabl, “Global Time in Distributed Real-Time Systems”; and Ganeriwal, Kumar, Srivastava, “Timing-sync Protocol for Sensor Networks”).

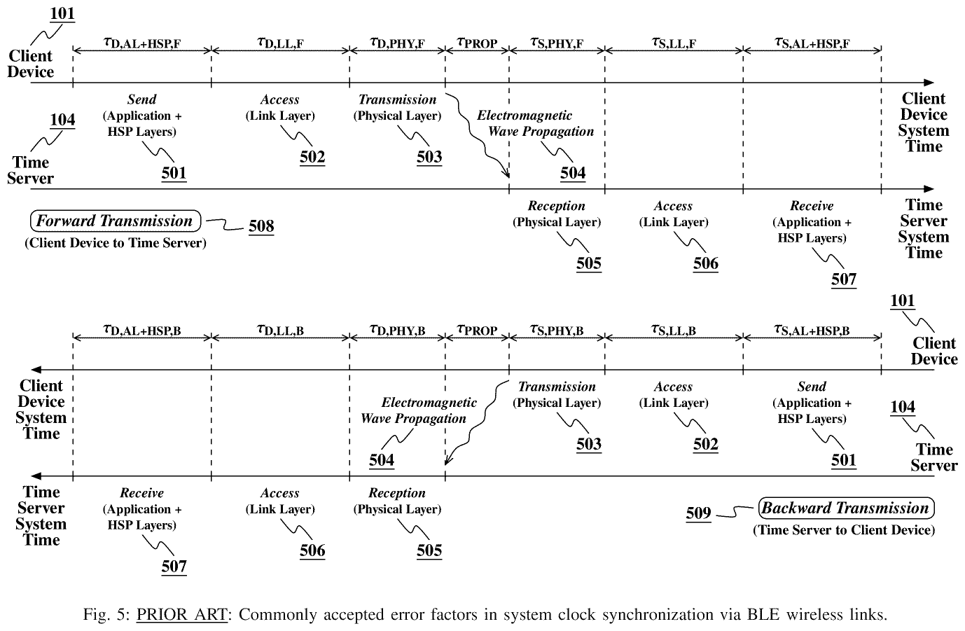

FIG. 5 illustrates the commonly accepted error factors affecting system clock synchronization over BLE wireless links, In this context, the transmission from a client device 101 to a time server 104 is referred to as the Forward Transmission 508, and the transmission from the time server 104 back to the client device 101 is referred to as the Backward Transmission 509. The error factors correspond to the various components of message propagation delay encountered in different stages of the BLE transmission, as enumerated below.
SEND 501, refers to the time it takes to transmit a data packet from the Application Layer (AL) 301, through the HSP layer 32, and down to the link layer 304. The delay τ_{D,AL+HSP,F} is encountered at the client Device 101 during the Forward transmission, while the delay τ_{S,AL+HSP,B} occurs at the time Server 104 during the Backward transmission.
ACCESS 502 refers to the time spent at the Link Layer (LL) 304 (or the MAC layer for other wireless standards) to handle conversions between data packets and bit-level transmissions. Specifically, it includes the time required to convert a data packet, which is received from the HSP layer 302, into a sequence of bits and make it available to the radio circuit of the BLE module 102/106. This delay is denoted as τ_{D,LL,F} at the client Device 101 during the Forward transmission and as τ_{S,LL,B} at the time Server 104 during the Backward transmission. On the other hand, ACCESS 506 refers to the time taken to convert a sequence of bits, which is received from the radio circuit of the BLE module 102/106 into a data packet and deliver it to the HSP layer 302. This delay is denoted as τ_{S,LL,F} at the time Server 104 during the Forward transmission and as τ_{D,LL,B} at the client Device 101. during the Backward transmission.
TRANSMISSION 503 refers to the time required at the Physical Layer (PHY) 305 to transmit a radio signal through the Antenna 103. This delay, denoted as τ_{D,PHY,F}, is encountered at the client Device 101 during the Forward transmission, and as τ_{S,PHY,B}, is encountered at the time Server 104 during the Backward transmission.
PROPAGATION 504 refers to the time required for an electromagnetic wave to travel from a transmitter to a receiver, denoted as τ_{PROP}. Due to the reciprocity of the wireless channel, the Forward and Backward propagation times, τ_{PROP,F} and τ_{PROP,B}, are equal, expressed as:

$${τ}_{PROP , F} = {τ}_{PROP , B} = {τ}_{PROP} . \qquad ( 7 )$$

RECEPTION 505 refers to the time required to receive a radio signal at the Physical Layer (PHY) 305 via the Antenna 103, This delay, denoted as τ_{S,PHY,F}, occurs at the time Server 104 during the Forward transmission, while τ_{D,PHY,B} occurs at the client Device 101 during the Backward transmission.
507 refers to the time required to process the received data packet at the Application Layer (AL) 301 and the HSP layer 302, This processing delay, denoted as τ_{S,AL+HSP,F} occurs at the time Server 104 during the Forward transmission, while τ_{D,AL+HSP,B} occurs at the client Device 101 during the Backward transmission.

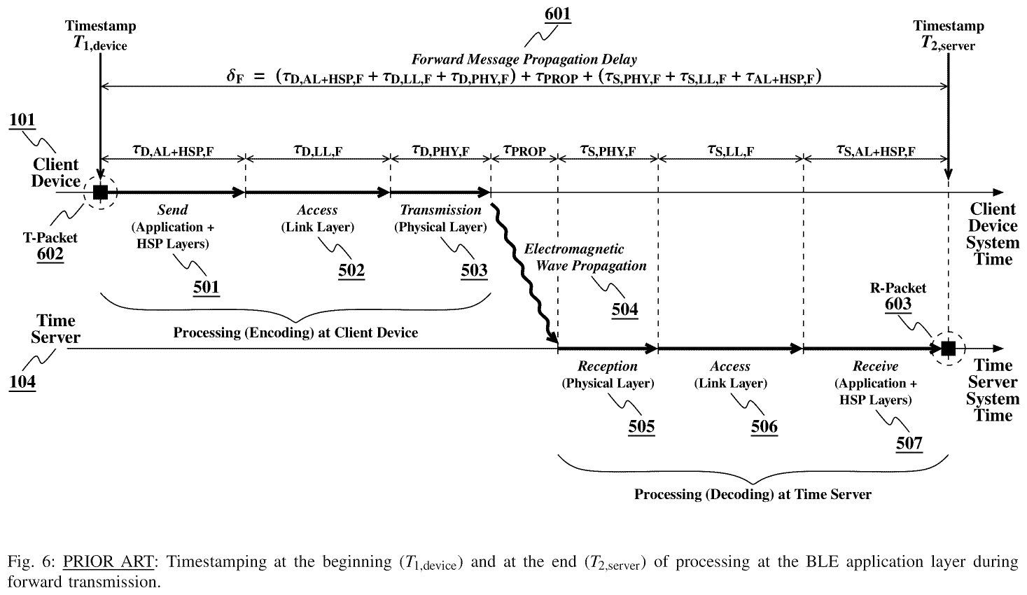

It has been reported that the Send 501, Access 502, and Receive 507 times, each exhibiting significant variability, are major contributors to overall message propagation delay (see Elson, Girod, and Estrin, “Fine—Grained Network Time Synchronization using Reference Broadcasts”; and Elson, “Time Synchronization in Wireless Sensor Networks”), As a result, timestamping performed at the application layer cannot yield accurate system clock synchronization. This limitation is illustrated in FIG. 6, which shows a scenario where timestamping occurs at the start and end of the application layer code during forward transmission. In this example, a Transmitted Data Packet (T-Packet) 602 originating from the client device 101 becomes the Received Data Packet (R-Packet) 603 at the time server 104. In this case, the Forward message propagation delay 601, δ_{F}, is given by Equation 8.

$${δ}_{F} = {\underbrace{( {τ}_{D , AL + HSP , F} + {τ}_{D , LL , F} + {τ}_{D , PHY , F} )}}_{Client Device Contribution} + {τ}_{PROP} + {\underbrace{( {τ}_{S , PHY , F} + {τ}_{S , LL , F} + {τ}_{S , AL , HSP , F} )}}_{Time Server Contribution} \qquad ( 8 )$$

Similar considerations apply to the backward propagation, where the Backward message propagation delay, δ_{B}, is given by Equation 9,

$${δ}_{B} = {\underbrace{( {τ}_{D , AL + HSP , B} + {τ}_{D , LL , B} + {τ}_{D , PHY , B} )}}_{Client Device Contribution} + {τ}_{PROP} + {\underbrace{( {τ}_{S , PHY , B} + {τ}_{S , LL , B} + {τ}_{S , AL , HSP , B} )}}_{Time Server Contribution} \qquad ( 9 )$$

Ideally, the forward and backward message propagation delays should be equal, as this condition reduces the system clock synchronization error, ε, to zero, as shown in Equation 6. However, when the forward and backward message propagation delays differ, an error, ε, is introduced into the estimated time offset, θ, as shown in Equation 5. As previously noted, there is no straightforward way to independently measure the forward and backward message propagation delays. Unfortunately, the largest sources of delay, those occurring at the application and HSP layers, are also the most variable, particularly when the communicating devices, namely the client device and the time server are produced by different vendors.

To reduce the impact of delays generated at the application and HSP layers. several techniques enabling timestamping at lower layers of the BLE protocol stack have been proposed. For example, the ‘Mica mote’ wireless sensor, developed at the University of California at Berkeley, provides software developers with direct access to the Media Access Control layer, thereby allowing more accurate timestamping during lower-layer message processing (see Nayak and Stojrnenovié, “Wireless Sensor and Actuator Networks: Algorithms and Protocols for Scalable Coordination and Data Communication”). Additionally, Nordic Semiconductor (Trondheim, Norway) has implemented a hardware interrupt mechanism in its processors (see “nRF51 Series Reference Manual,” Nordic Semiconductor), which supports timestamping at the BLE physical layer 305.

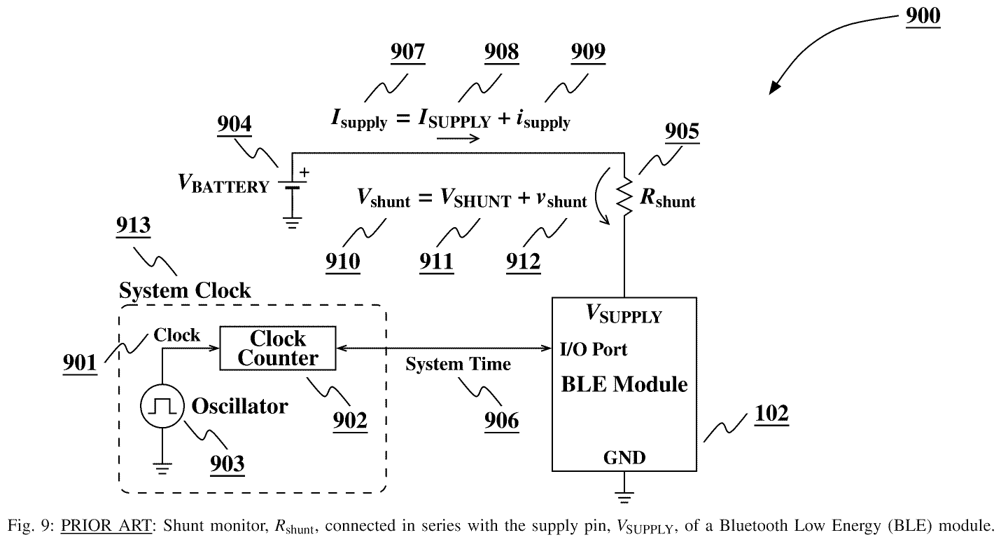

In academic research, the Circuit 900 shown in FIG. 9 has been proposed. It comprises a BLE Module 102 powered by a battery 904, which supplies the operating voltage. The System Clock subsystem 913 of the BLE Module 102 includes (i) a Clock Counter 902 that generates the System Time 906 of the BLE device 901, and (ii) an Oscillator 903 that provides the Clock Signal 901 to the clock counter 902. Crucially, the circuit 900 also incorporates a shunt resistor 905, denoted Rₛₕᵤₙₜ, placed in series with the supply pin of a BLE Module 102. This resistor is used to sense the supply current 907, I_{supply}, which consists of a DC component 908, I_{SUPPLY} and an AC component 909, i_{supply}, as expressed in Equation 10.

$${I}_{supply} = {\underbrace{{I}_{SUPPLY}}}_{DC} + {\underbrace{{i}_{supply}}}_{AC} \qquad ( 10 )$$

The supply current 907, I_{supply}, flowing through the shunt resistor 905, Rₛₕᵤₙₜ produces a corresponding shunt voltage drop 910, Vₛₕᵤₙₜ. This voltage drop also consists of a DC component 911, V_{SHUNT}, and an AC component 912, νₛₕᵤₙₜ, as expressed in Equation 11.

$${V}_{shunt} = {\underbrace{{V}_{SHUNT}}}_{DC} + {\underbrace{{v}_{shunt}}}_{AC} \qquad ( 11 )$$

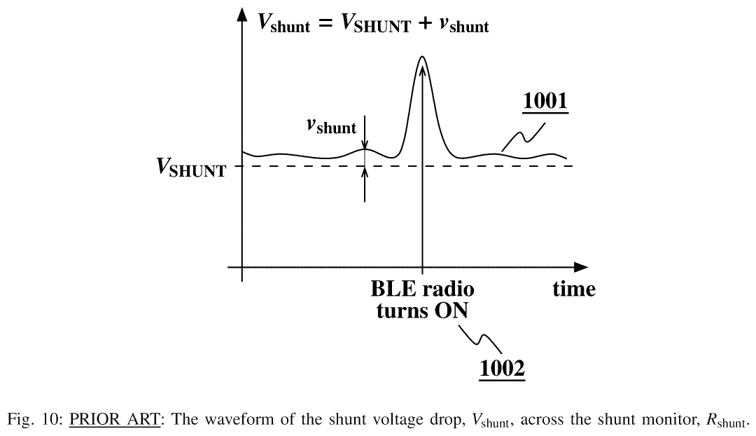

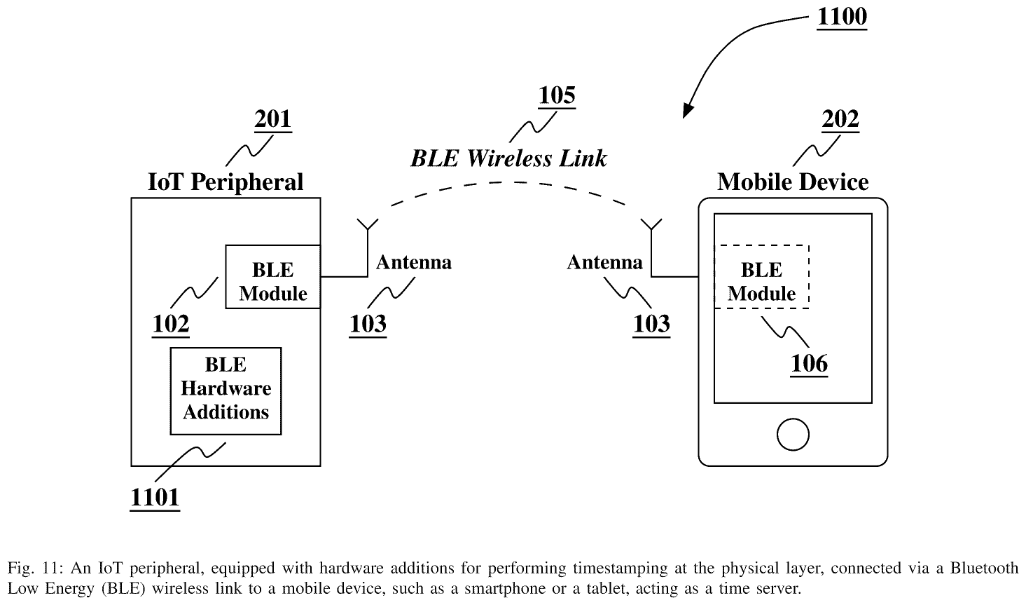

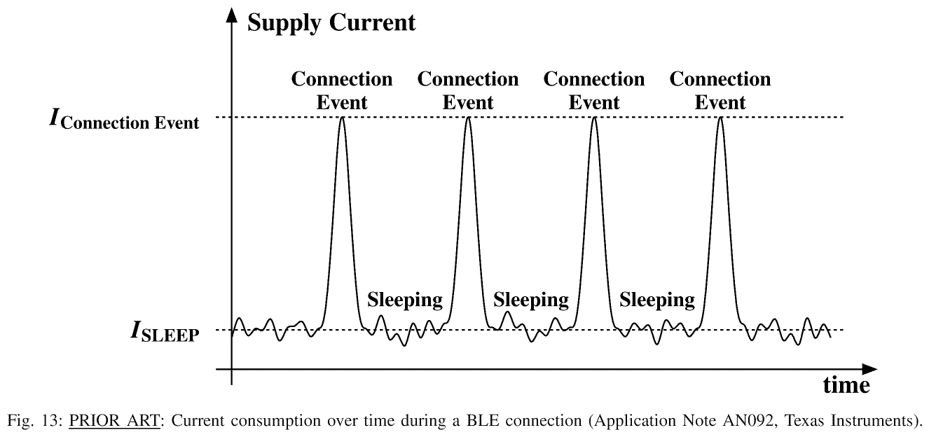

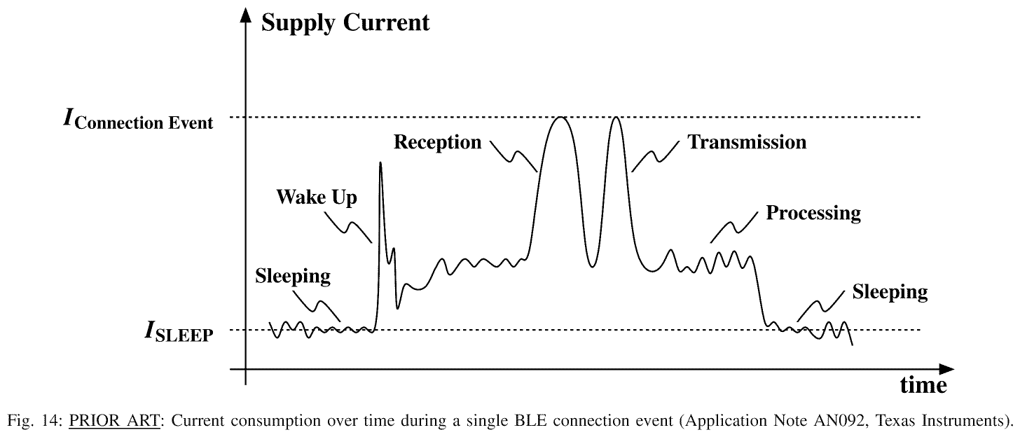

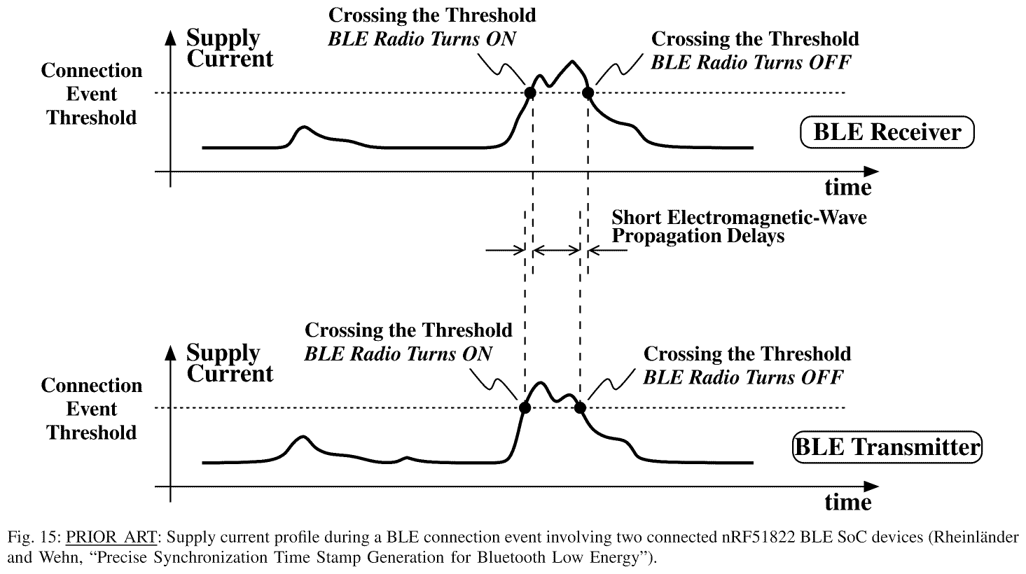

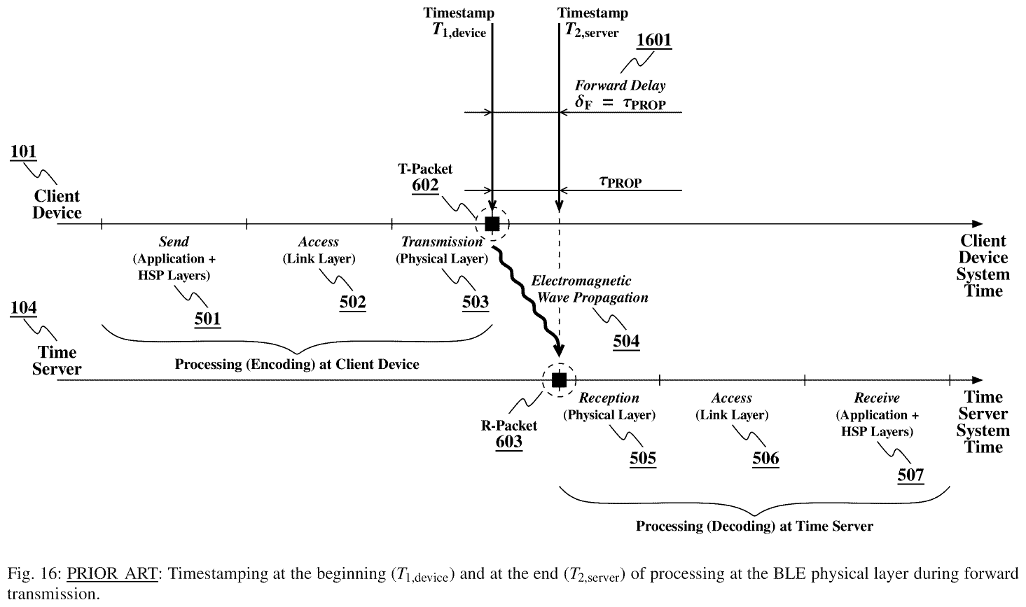

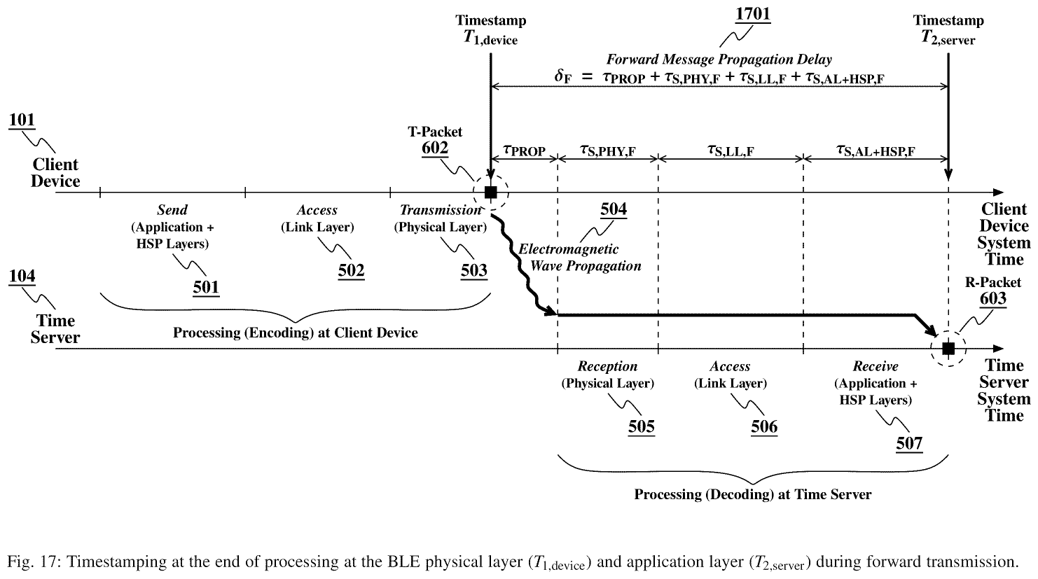

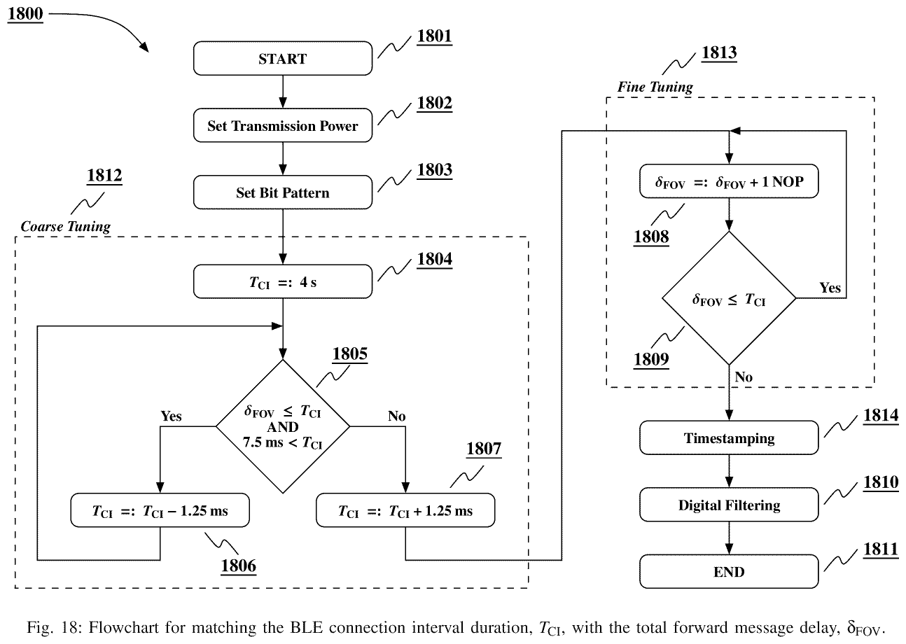

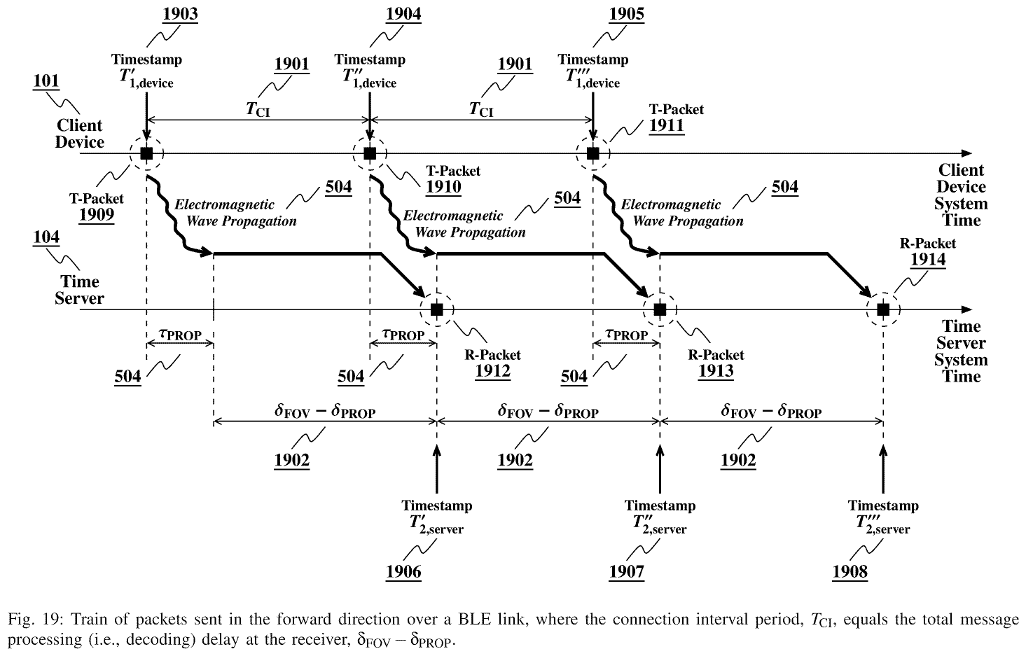

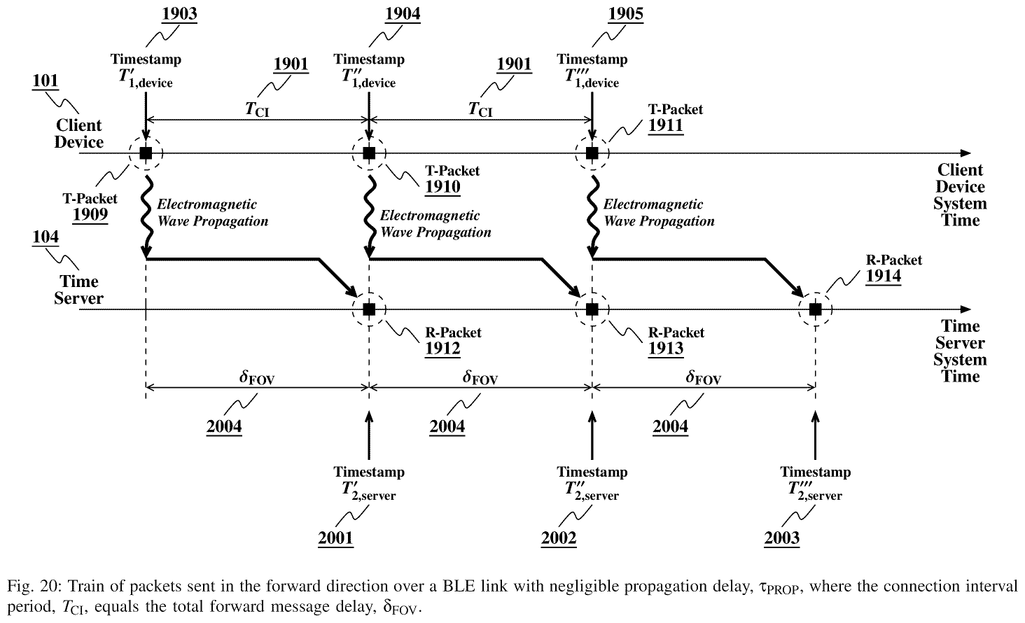

FIG. 10 illustrates the waveform 1001 of the shunt voltage drop 910, Vₛₕᵤₙₜ, where a distinct voltage spike can be observed at the moment 1002 when the BLE radio circuit turns ON. Since the power consumption of the BLE module 102 varies quadratically with the supply current 907, I_{supply}, and hence with the shunt voltage drop 910, Vₛₕᵤₙₜ, it is feasible to infer the ON/OFF state of the BLE radio circuit from the device's power consumption pattern. This principle has been demonstrated in prior studies (see Rheinlander and Wehn, “Precise Synchronization Tirme Stamp Generation for Bluetooth Low Energy”; Yousefi, Somaratne. and Dian, “Analysis of Time Synchronization based on Current Measurement for Bluetooth Low Energy (BLE)”; Somaratne, Dian, and Yousefi, “Accuracy Analysis of Time Synchronization using Current Consumption Pattern of BLE Devices”; and Dian, Yousefi, and Somaratne, “Performance Evaluation of Time Synchronization using Current Consumption Pattern of BLE Devices”). FIGS. 13 and 14 confirm that the ELF radio unit is the dominant contributor to the overall power consumption of a BLE device during a BLE connection event (see Kamath and Lindh, “Measuring Bluetooth Low Energy Power Consumption,” Application Note AN092, Texas Instruments). Consequently, as illustrated in FIG. 15, it is feasible to accurately detect the precise time at which the BLE radio turns ON and OFF by monitoring the supply current, or equivalently, the power consumption, crossing a defined connection event threshold. This technique enables physical-layer timestamping (see Rheinlander and Wehn, “Precise Synchronization Time Stamp Generation for Bluetooth Low Energy”). When timestamping is performed at the physical layer, the only significant contributor to the message propagation delay-both forward and backward—is the propagation delay, τ_{PROP}, as shown in FIG. 16 and expressed in Equation 12.

$${δ}_{F} = {δ}_{B} = {τ}_{PROP} \qquad ( 12 )$$

This delay is minimal, given that electromagnetic waves travel at the speed of light. Consequently, the overall message propagation delay 1601 is small, which results in a reduced synchronization error, C.

It is noted that the aforementioned techniques are effective primarily for custom-designed communicating devices, as commercial mobile devices, such as smartphones or tablets, cannot be readily modified to incorporate hardware support for low-layer timestamping, In scenarios where a communicating device equipped with physical-layer timestamping capability is connected to a commercial mobile device acting as a time server (see FIG. 17), the forward and backward message propagation delays are given by:

$${δ}_{F} = {τ}_{PROP} + {\underbrace{( {τ}_{S , PHY , F} + {τ}_{S , LL , F} + {τ}_{S , AL + HSP , F} )}}_{Time Server Contribution} \qquad ( 13 )$$

$${δ}_{B} = {τ}_{PROP} + {\underbrace{( {τ}_{S , PHY , B} + {τ}_{S , LL , B} + {τ}_{S , AL + HSP , B} )}}_{Time Server Contribution}$$

Since the radio propagation delay, τPROP, is negligible compared to the delays generated at the application and link layers in most practical scenarios—owing to the fact that electromagnetic waves propagate at the speed of light-Equations 13 can be simplified as follows:

$${δ}_{F} \approx {\underbrace{{τ}_{S , PHY , F} + {τ}_{S , LL , F} + {τ}_{S , AL + HSP , F}}}_{Time Server Contribution} \qquad ( 14 )$$

$${δ}_{B} \approx {\underbrace{{τ}_{S , PHY , B} + {τ}_{S , LL , B} + {τ}_{S , AL + HSP , B}}}_{Time Server Contribution}$$

The present invention discloses mechanisms and methods for independently estimating the forward and backward message propagation delays. δ_{F} and δ_{B}, which are significantly affected by both the magnitude and variability of the delays generated at the application and link layers, as evident in Equations 14.

A second option that provides programmers with the ability to perform timestamping at lower layers is the use of a Real-Time Operating System (RTOS). However, this approach falls outside the scope of the present disclosure, as most commercial smartphones and tablets do not run such operating systems.

### PRIOR ART

As mentioned in the previous sections, the large variations in message propagation delay are a major source of error in system clock synchronization over wireless links in general, and BLE links in particular. To mitigate these variations in BLE-based communication, several protocols have been proposed, as described below, In the Reference Broadcast Synchronization (RBS) protocol, the system clocks of multiple client devices connected to a local network are synchronized based on the arrival time of a reference message broadcast by a time server (see J. E. Elson, “Time Synchronization in Wireless Sensor Networks”; Elson, Girod, and Estrin, “Fine-Grained Network Time Synchronization using Reference Broadcasts”; and Elson and Estrin, “Time Synchronization for Wireless Sensor Networks”). To achieve synchronization, each client device records its local system time upon receiving the reference message and then exchanges this recorded time with the other client devices in the network. Since synchronization relies only on the reference message's arrival time, and not on its propagation delay, the large variations in reference message's propagation delay do not affect the synchronization accuracy. However, RBS enables synchronization only among the client devices that receive the reference message; it does not allow synchronization with the time server itself. Consequently, the RBS protocol is not applicable for synchronizing a peripheral with a time server in point-to-point communication scenarios, A workaround involves having the client devices broadcast beacon messages in a round-robin fashion, allowing each to act as the time server in turn. However, this approach requires at least three client devices. In contrast, the present disclosure proposes accurate system clock synchronization between only two devices, specifically, an IoT peripheral and a mobile device, connected via a point-to-point BLE link.

The Timing-sync Protocol for Sensor Networks (TPSN) algorithm (see Ganeriwal, Kumar, and Srivastava, “Timing-sync Protocol for Sensor Networks”) first organizes the local network into a hier-archical tree of communicating devices, and then performs pairwise synchronization along the edges of this tree. To synchronize its system clock, a communicating device exchanges two synchronization messages with its reference communicating device, which is positioned one level higher in the hierarchy. TPSN claims to achieve high synchronization accuracy due to each communicating device's ability to perform timestamping at the MNAC-layer level of the protocol stack. In contrast, the present disclosure enables accurate system clock synchronization between a communicating device and a time server that lacks the capability to perform timestamping at lower layers of the BLE protocol stack. In the Flooding Time Synchronization Protocol (FTSP) algorithm (see Mar6ti, Kusy, Simon, and Lédeczi. “The Flooding Time Synchronization Protocol”), each communicating device is equipped with a ‘Mica mote’ wireless sensor (see Nayak and Stojmenovié, “Wireless Sensor and Actuator Networks: Algorithms and Protocols for Scalable Coordination and Data Communication”), which is capable of performing timestamping at the physical layer of the protocol stack. In contrast, the present disclosure enables accurate synchronization between a communicating device and a time server over a point-to-point BLE link, even when the time server lacks capability to perform timestamping at a low layer of the BLE protocol stack,

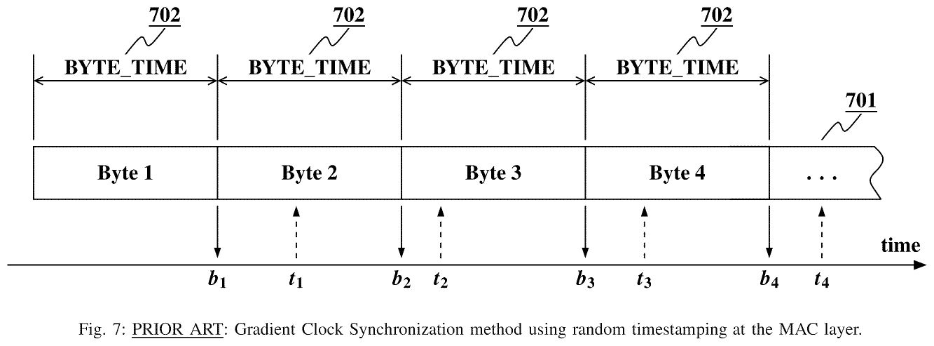

In the Gradient Time Synchronization Protocol (see Sommer and Wattenhofer, “Gradient Clock Synchronization in Wireless Sensor Networks”) timestamping is performed at the MAC layer. As shown in FIG. 7, an interrupt is generated at time bᵢ, where i=1,2, . . . , upon the arrival of a new data byte in the byte string 701. This interrupt triggers an interrupt service routine, which samples the system time at time tᵢ≥bᵢ, where i=1,2, . . . , followed by storing the sampled value in memory. The time difference tᵢ-bᵢ, where i 1,2, . . . , is highly variable due to the non-deterministic processing latency of the interrupt service routine. Assume that BYTE__TIME 702 denotes the period of the transmitted byte string. A more accurate estimation of the timestamp tᵢ is given by:

$${t}_{i}^{′} = min ( {t}_{i} , {t}_{i + 1} - BYTE\_TIME ) \qquad ( 15 )$$

since t_{is closer to the actual interrupt generation time bs than t. This technique effectively reduces the time difference t, b}ᵢ, where i=1,2, . . . , thereby improving the synchronization accuracy. The present disclosure claims that accurate synchronization is achievable even when one of the communicating devices. specifically the time server, lacks low—layer timestamping capability. Furthermore, it introduces a method to drive the difference tᵢ -bᵢ toward zero, as described in the next section,

The Precision Time Protocol (PTP) addresses system clock synchronization in local area networks based on Ethernet technology (see “IEEE Standard for a Precision Clock Synchronization Protocol for Networked Measurement and Control Systems,” IEEE Std 1588TM12008; and “Precision Clock Synchronization Protocol for Networked Measurement and Control Systems,” IEC 61588:2009). In PTP, timestamping is performed at the physical layer with hardware assistance. Extending PTP to wireless networks has been explored in various academic studies. Cho et al. (see Cho, Jung, Cho, Jin, Lee, and Back, “Precision Time Synchronization Using IEEE 1588 for Wireless Sensor Networks”) proposed connecting a wireless sensor network to a wired network through an Ethernet switch. The Wireless Precision Time Protocol (WPTP) is an adaptation of PTP for multi-hop wireless networks, designed to reduce the number of synchronization messages exchanged within the wireless network (see Garg, Yadav, Sikora, and Sairam, “Wireless Precision Time Protocol”). In contrast to PTP and WPTP, the present disclosure focuses on two communicating devices connected via a point-to-point BLE link. It describes a mechanism and method for syncronizing a client device with a time server that lacks the capability to perform low-layer timestamping within the BLE stack,

To mitigate the large variations in BLE message propagation delays, the CheepSync method (see Sridhar, Misra, Gill, and Warrior, “Cheepsyne: A Time Synchronization Service for Resource Constrained Bluetooth BLE Advertisers”) employs low-layer timestamping at both the transmitter and receiver ends of the BLE link. In contrast, the present disclosure introduces a method in which low-layer timestamping is required only at one end of the BLE link, specifically, at the client device.

Researchers Bideaux et al. (see Bideaux, Zimmermann, -ley, and Stork, “Synchronization in Wireless Biomedical-Sensor Networks with Bluetooth Low Energy”) and Dian et al. (Dian, Yousefi, and Somaratne, “A Study in Accuracy of Time Synchronization of BLE Devices using Connection-Based Event”) have investigated the use of a so-called ‘connected event,’ which is generated at the application layer, as a common time reference for synchronizing two identical communicating devices. The researchers claim that the ‘connected event’ occurs simultaneously in the two communicating devices, However, this is a very optimistic assumption that overlooks the high variability in message propagation and processing delays at the application layer in BLE communications, particularly when involving heterogenous communicating devices, such as an IoT peripheral and a mobile device, as considered in the present disclosure. Ghoshdastider, Viga, and Kraft, have proposed a method for synchronizing the system clocks of a group of more than three BLE sensors that lack the capability for low-layer timestamping within the BLE protocol stack (Ghoshdastider, Viga, and Kraft, “Wireless Time Synchronization of a Collaborative Brain-Computer-Interface using Bluetooth Low Energy”). Their method, however, does not address the synchronization of a sensor, such as a client device with low-layer timestamping capability within the BLE protocol stack, connected via a point-to-point BIE link to a time server that lacks such capability, as considered in the present disclosure.

Noh, Serpedin, and Qarage have proposed a method for synchronizing a set of wireless sensors to an existing pair of already synchronized wireless sensors, without transmitting additional synchronization messages beyond those already exchanged between the wireless sensors in said pair (see Noh, Serpedin, and Qarage, A New Approach for Time Synchronization in Wireless Sensor Networks: Pairwise Broadcast Synchronization”). In contrast, the present disclosure describes a mechanism and method for achieving accurate system clock synchronization in a network consisting of only two communicating devices connected via a point-to-point BLE link.

In the BlueSyne protocol, a time server and all client devices connected to a local network are equipped with physical-layer timestamping capabilities (see Asgarian and Najafi, “BlueSync: Time Synchronization in Bluetooth Low Energy with Energy-Efficient Calculations”). In contrast to the BlueSync protocol, the present disclosure describes a method in which physical-layer timestamping is required only at one end of a point-to-point link, specifically, at the client device.

Harada et al. claim that the one-way message propagation delay between a base station and an IoT sensor is a fixed value that can be obtained experimentally through measurement (Harada, Izumi, Kozeni, Yoshikawa, Ishii, and Kawaguchi, “20-μs Accuracy Time-Synchronization Method using Bluetooth Low Energy for Internet-of-Things Sensors”). This claim holds true for static IoT clients connected to a static base station, where the wireless channel can be characterized-specifically, its gain and propagation delay—prior to establishing the connection. However, in wireless networks involving mobile IoT clients, it is not economically feasible to measure the wireless channel for every possible client location in an end-user environment before the connection is established. In contrast, the present disclosure assumes that the message propagation delay is unknown. Nevertheless, it describes a mechanism and method for accurately estimating the time offset between the system times of two communicating devices after a BLE connection has been established.

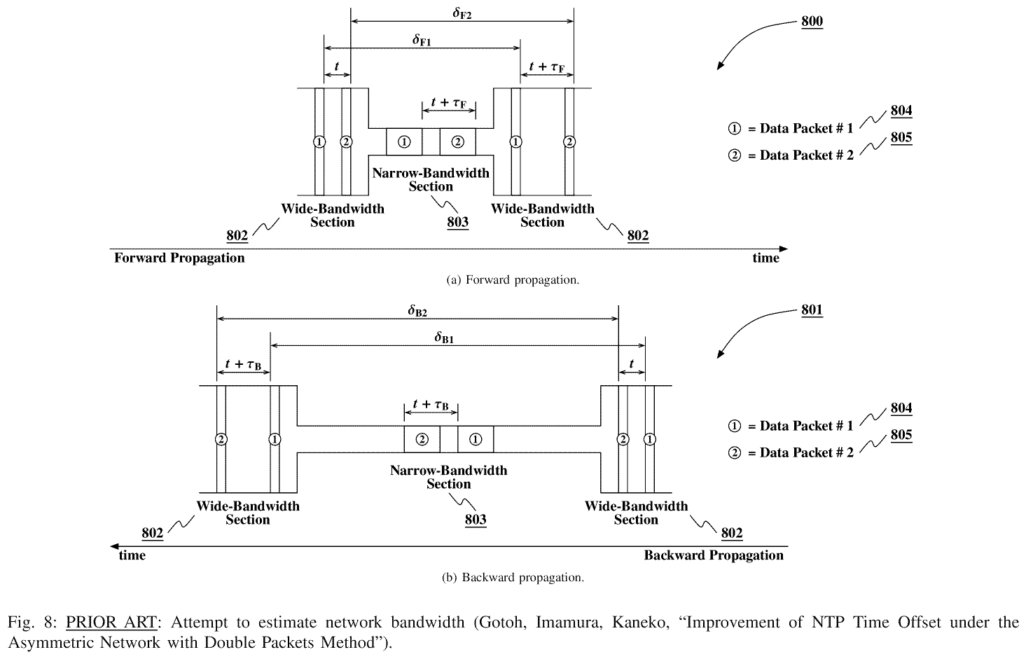

See Equation 5 and FIG. 8. In an effort to reduce the system clock synchronization error, ε, researchers Gotoh, Imamura, and Kaneko attempt to estimate the network bandwidth by transmitting two data packets, Data Packet #1 804 and Data Packet #2 805, at a very short time interval, t (see Gotoh, Imarmura, Kaneko, “Improvement of NTP Time Offset under the Asymmetric Network with Double Packets Method”). If the network includes two wide-bandwidth sections 802, separated by a narrow-bandwidth section 803, the time interval between the two data packets increases by τ_{F} and τ_{B} during the forward propagation 800 and backward propagation 801, respectively. Researchers Gotoh, Imamura, and Kaneko claim that the forward and backward message propagation delays, δ_{F} and δ_{B}, are proportional to these additional time intervals, τ_{F} and τ_{B}, as expressed in Equation 16 shown below.

$${δ}_{F} = \frac{{τ}_{F}}{{τ}_{F} + {τ}_{B}} δ \qquad ( 16 )$$

$${δ}_{B} = \frac{{τ}_{B}}{{τ}_{F} + {τ}_{B}} δ$$

$$δ = {δ}_{F} + {δ}_{B}$$

where δ is the roundtrip delay. The author of the present invention believes that this claim is incorrect, as network bandwidth is proportional to throughput, not to delay (which is also referred to as latency). As a counter—example in support of this argument. FIGS. 8a and 8b illustrate two narrow-bandwidth network sections 803 with equal bandwidths, for which

$${τ}_{F} = {τ}_{B} ⇒ \frac{1}{{τ}_{F}} = \frac{1}{{τ}_{B}} , \qquad ( 17 )$$

yet the message propagation delays are highly asymmetric:

$${δ}_{F 1} \neq {δ}_{B 1} \qquad ( 18 )$$

$${δ}_{F 2} \neq {δ}_{B 2} .$$

Mani et al. claim that it is possible to correct system clock synchronization error introduced by asymmetric path delays by identifying whether the asymmetry originates in the forward or backward path (see Mani, Durairajan, Barford, and Sommers, “An Architecture for IoT Clock Synchronization”; and Mani, Durairajan, Barford, and Sommers, “A System for Clock Synchronization in an Internet of Things”). The author of the present invention believes that this claim is incorrect. According to Equation 5, the actual time offset, θ, equals the estimated time offset, θ, plus an error, ε, which depends on both the forward and backward message propagation delays, δ_{F} and δ_{B}, With a single equation and three unknowns, specifically, θ, δ_{F}, and δ_{B}, the system is underdetermined, meaning that there are infinitely many possible solutions (see, for example, Strang, “Introduction to Linear Algebra,” sixth edition),

Professor Judah Levine of the University of Colorado at Boulder proposed an algorithm for system clock synchronization over networks with unstable delays (see Judah Levine, “An Algorithm for Synchronizing a Clock When the Data Are Received Over a Network With an Unstable Delay”). In contrast to the present disclosure, the cited work assumes a circuit-switched telephone network with, on average, symmetrical message propagation delay and variable asymmetry, The present disclosure, however, considers a wireless connection with no assumption regarding the symmetry of the message propagation delay.

In U.S. Pat. No. 11,647,371 B2 (see Chen, “Synchronization of Bluetooth Low Energy Isochronous Transmissions”) and U.S. Pat. No. 11,075,968 B1 (see Chen, “Synchronization of Bluetooth Low Energy Transmission Across Connected Isochronous Groups”), the inventor Chen discloses mechanisms and methods for synchronizing all data channels of a BLE transmission. However, synchronization of the system clock with a time server is not addressed in these patents, whereas this is the primary focus of the present disclosure,

In U.S. Pat. No. 10,462,759 B2 (see Kerai, “System and Method for Clock Synchronization on a Wireless Network”), the inventor Kerai claims that a BLE Advertiser, referred to as the Slave device after the BLE connection is established, can receive a message carrying a timestamp from a BLE initiator, referred to as the Master device after the BLE connection is established, in approximately 1 μs, and use that timestamp to accurately set its system clock. Such a very short message propagation delay is a very strong claim, which is valid only under the assumption that both communicating devices possess low-layer timestamping capability (as discussed in Rheinlatnder and Wehn, “Precise Synchronization Time Stamp Generation for Bluetooth Low Energy”; and Yousefi, Somaratne, and Dian, “Analysis of Time Synchronization based on Current Measurement for Bluetooth Low Energy (BLE)”). The present disclosure describes a method for accurate system clock synchronization in a two-device BLE network in which only the client device, equivalent to a slave device in the Kerai's patent, has low-layer timestamping capability.

In U.S. Pat. No. 10,187,235 B2 (see Zhang, “Long Range Bluetooth Low Energy Synchronization System”), the inventor Zhang discloses a synchronizer for a Long-Range Bluetooth Low Energy (LR BLE) receiver. This synchronizer can be configured to lock onto the clock phase of the incoming data stream, capture the access address code in the LR BLE packet, and provide timing information to the demodulator for decoding the payload data. It should be noted that Zhang's disclosure does not overlap with the present disclosure, which describes a method to synchronize the system clocks of two communicating devices via a standard BLE link rather than an LR BLE link.

U.S. Pat. No. 9,848,069 B2 (see Geboff et al., “Device Synchronization over Bluetooth”) dis—closes methods for synchronizing devices over Bluetooth communication channels using link layer (i.e., low-layer) messages. It is important to note that timestamping at low layers (link or physical) is generally not supported in Bluetooth devices, although some vendors do implement this feature (see, for example, “nRF51 Series Reference Manual,” Nordic Semiconductor), The present disclosure describes a method for achieving accurate system clock synchronization over BLE links, in which only one of the two communicating devices, specifically, the client device, has low-layer timestamping capability.

U.S. Pat. No. 9,426,749 B2 (see Cordeiro et al., “Method and Apparatus for Bluetooth-Based Wi-Fi Synchronization”) discloses a method for synchronizing devices by exchanging Wi-Fi synchronization information via Bluetooth packets. In contrast, the present disclosure describes a synchronization method that relies solely on a Bluetooth Low Energy (BILE) connection.

U.S. Pat. No. 7,602,873 B2 (see Eidson, “Correcting Time Synchronization Inaccuracy Caused by Asymmetric Delay on a Communication Link”) discloses a technique for correcting system clock synchronization inaccuracy caused by asymmetric message propagation delays over a communication link composed of two wired channels (referred to in the patent as ‘two portions of a communication link’). with each wired channel being exercised for both the forward and backward propagation directions. In contrast, the present disclosure involves only a single wireless communication channel, with delay estimation performed through unidirectional message propagation.

### DETAILED DESCRIPTION OF THE INVENTION

This invention discloses mechanisms and methods for synchronizing the system clock of a client device, such as an IoT peripheral or a mobile sensor, with the system clock of a mobile device acting as a time server, such as a tablet or a smartphone, over a BLE, link. In the following discussion, the client device initiates the synchronization procedure by sending messages to the time server. However, the disclosed method can be adapted when the roles of the client device and time server are swapped.

FIG. 11 illustrates the architecture of the system 1100 proposed in this disclosure. The system includes (i) a mobile device 202 acting as a time server, such as a commercial smartphone or tablet, which lacks the capability of performing timestamping at the lower layers of the BLE stack 300, and (ii) an IoT peripheral 201 acting as a client device, which is connected to the mobile device 202 via a BLE wireless link 105, The IoT peripheral 201 includes Hardware Additions 1101 to its BLE module 102, enabling it to perform timestamping at the physical layer 305 of the BLE stack 300.

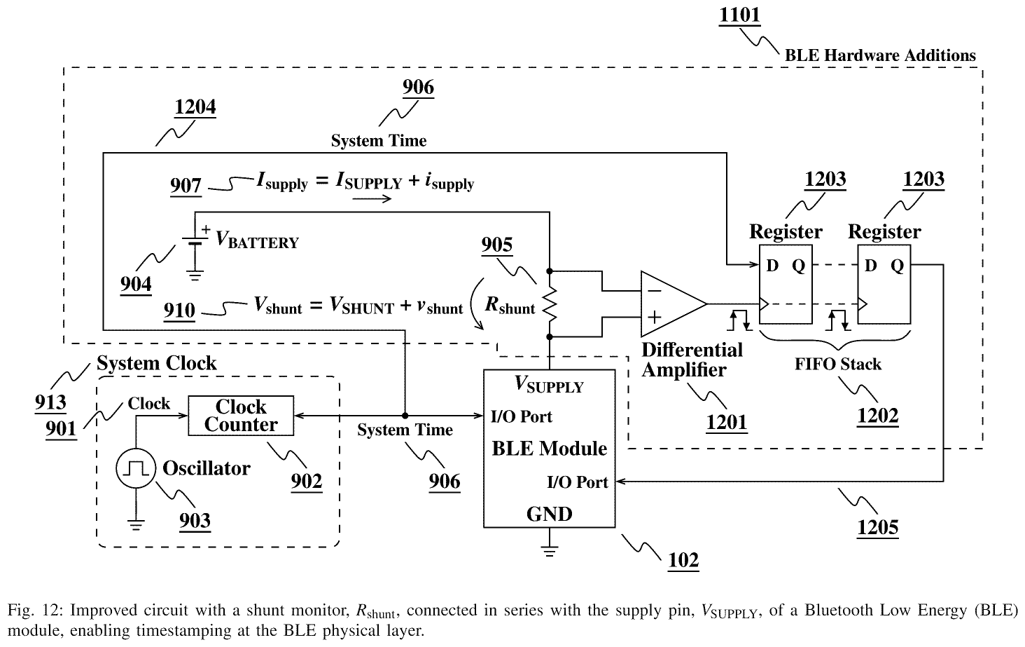

As shown in FIG. 12, the hardware additions 1101 include a shunt resistor 905, denoted as Rₛₕᵤₙₜ, connected in series with the voltage supply pin, V_{SUPPLY}. of the BLE module 102, which may be incorporated into a general client device 101 or a specific IoT peripheral 201, The hardware additions 1101 also include a Differential Voltage Amplifier 1201, which senses the supply current 907, I_{supply} flowing through the shunt resistor 905, Rₛₕᵤₙₜ, and a First-In First-Out (FIFO) Stack 1202 composed of a series connection of D-Type Registers 1203 that are capable of switching on both the rising and falling edges of their clock signal. As sensed by the differential voltage amplifier 1201, the FIFO stack 1202 stores timestamps corresponding to increases and decreases in the supply current above and below predefined thresholds, respectively. These timestamps are transferred to the FIFO stack 1202 via bus 1204, and uploaded into the BLE module 102 via bus 1205. Because the radio unit is a major contributor to the power consumption of the BLE device, the stored timestamps accurately capture the moments when the BLE radio unit of the BLE module 102 turns ON and OFF, that is, when the radio signal is transmitted from the BLE device via electromagnetic radiation. This approach effectively implements timestamping at the physical layer of the BLE device.

Unlike the client device, which performs timestamping at the physical layer, the mobile device cannot perform timestamping at a low layer in the BLE stack 300. Therefore, it performs timestamping at a higher layer in the BLE stack 300, specifically at the application layer 301. As a result, the forward message propagation delay 1701, denoted as δ_{F}, includes the radio signal propagation delay, τ_{PROP}; the physical layer delay, τ_{S,PHY,F}; the link layer delay, τ_{S,LL,F}; and the application layer delay, τ_{S,AL+HSP,F}, with the last three delays corresponding to received message processing on the mobile device, namely message decoding. This is illustrated in FIG. 17. Similar considerations apply to the backward message propagation delay, δ_{B}, in another embodiment of the invention, where δ_{B} includes the radio signal propagation delay, τ_{PROP}; the physical layer delay, τ_{S,PHY,B}; the link layer delay, τ_{S,LL,B}; and the application layer delay, τ_{S,AL+HASP,B}, with the last three delays corresponding to transmitted message processing on the mobile device, namely message encoding.

Unlike in large-scale multi-hop networks, routing delay is absent in BLE point-to-point connections, Consider a scenario in which the IoT peripheral and the mobile device are placed in close proximity. Since the electromagnetic waves propagate with the speed of light, the radio signal propagation delay, τ_{PROP}, becomes negligible compared to all other delays in the algebraic sum of Equation 13. Consequently, the forward message propagation delay, δ_{F} (or the backward message propagation delay, δ_{B}, in another embodiment of the invention), consists approximately of the physical layer delay, τS,PHY,F, link layer delay, τ_{S,LL,F}, and application layer delay, τ_{S,AL+HSP,F}, as shown in Equation 14. In other words, in a point-to-point BLE connection with communicating devices located in close proximity, the message propagation delay is dominated by data processing (decoding or encoding) delays at the various protocol stack layers. As shown in FIG. 15, the BLE radio units of the IoT peripheral and the mobile device become active at approximately the same time, since the short delay encountered, τ_{PROP}, results from radio signal propagation at the speed of light (see Kamath and Lindh, “Measuring Bluetooth Low Energy Power Consumption”; and Rheinlander and Wehn, “Precise Synchronization Time Stamp Generation for Bluetooth Low Energy”). From the perspective of practical implementation of system clock synchronization over BLE wireless links, this implies that when a data packet leaves the transmitter, it can be considered, with very good approximation, as having already arrived at the receiver.

To accurately estimate the time offset between two communicating devices, the overhead delay introduced by the operating system, denoted as δ_{OV}, must be added to both the forward message propagation delay, δ_{F}, and backward message propagation delay, δ_{B}. Unlike operating systems for desktop or mainframe computers, such as Windows, Linux, and macOS, the operating systems used in commercial mobile devices, including iOS, iPadOS, and Android, can be configured to run only critical services, with all non-essential tasks being placed into sleep mode. Consequently, it is indeed possible to minimize the overhead delay, δ_{OV}, on such commercial mobile devices.

Based on the information presented in previous sections, the critical task in system clock synchronization is the independent determination of the total forward message delay,

$${δ}_{FOV} = {δ}_{F} + {δ}_{OV} , \qquad ( 19 )$$

and/or the total backward message delay,

$${δ}_{BOV} = {δ}_{B} + {δ}_{OV} . \qquad ( 20 )$$

It is noted that in Bluetooth Low Energy (BLE), the time between connection events-during which the communicating devices exchange messages in the form of data packets—is defined as the BLE Connection Interval (CI), denoted as T_{CI} (see “The Bluetooth Low Energy Primer:” Bluetooth Special Interest Group; M. Afaneh, “Intro to Bluetooth Low Energy: Learn Bluetooth Low Energy in a single weekend”; and R, Heydon, “Bluetooth Low Energy: The Developer's Handbook”). The key idea of the present disclosure for independently determining message propagation delays is to iteratively tune the duration of the BLE Connection Interval so that it equalizes the total forward message delay, δ_{FOV} (or the total backward message delay, δBOV, in an alternative embodiment of the invention). In essence, the BLE connection interval is employed as a measurement tool for estimating the total forward or backward message delay, According to the BLE standard (see “The Bluetooth Low Energy Primer,” Bluetooth Special Interest Group; Mohammad Afaneh, “Intro to Bluetooth Low Energy: Learn Bluetooth Low Energy in a single weekend”; and Robin Heydon, “Bluetooth Low Energy: The Developer's Handbook”), the BLE connection interval is configurable within a range from 7.5 milliseconds to 4 seconds, with a resolution of 1 25 milliseconds. In the disclosed method, a periodic train of data packets is transmitted with a period equal to the BLE connection interval, which is iteratively decreased from the maximum of 4 seconds down to the minimum of 7.5 milliseconds, in decrements of 1.25 milliseconds, At the receiver, the period of the reconstructed train of data packets remains equal to the BLE connection interval as long as the total message delay is less than the BLE connection interval:

$${δ}_{FOV} = {δ}_{F} + {δ}_{OV} \leq {T}_{CI} , \qquad ( 21 )$$

which indicates that the receiver has sufficient time to decode each received data packet within a time interval equal to the BLE connection interval. The iterative process terminates when the period of the reconstructed train of data packets exceeds the BLE connection interval, that is, when the total message delay surpasses the configured BLE connection interval:

$${δ}_{FOV} = {δ}_{F} + {δ}_{OV} > {T}_{CI} \qquad ( 22 )$$

This situation arises when a new data packet arrives before the current data packet has been fully decoded by the receiver, As a result, the iterative process identifies the shortest BLE connection interval, denoted as T_{CI,min,} that matches the total forward message delay, δ_{FOV} (or the total backward message delay, δ_{BOV}, in an alternative embodiment of the invention). Mathematically, this relationship can be expressed as:

$${T}_{CI , min} = {min}_{{δ}_{FOV} \leq {T}_{CI}} {T}_{CI} \qquad ( 23 )$$

It is observed that the BLE connection interval increment, which is equal to 1.25 ms, determines the numerical accuracy with which T_{CI,min} can be estimated.

In yet another embodiment of the invention, the approach to equalizing the BLE connection interval with the total forward or backward message delay is reversed. Instead of iteratively adjusting the BLE connection interval to match the total forward or backward message delay, the BLE connection interval is held constant at a predefined value, while the total forward or backward message delay is iteratively tuned to match it. This tuning process is performed by inserting dummy operations, such as No-OPeration (NOP) instructions, into the code running at the application layer, thereby artificially increasing the total forward or backward message delay. δ_{FOV} or δ_{BOV}, respectively, For a smartphone or tablet operating at a clock frequency of 1 GHz, a tuning resolution of 1 microsecond, which is equivalent to approximately 1000 clock cycles or a few hundred dummy operations, can be readily achieved.

In still another embodiment of the invention, both tuning techniques are applied sequentially to improve the accuracy of equalizing the BLE connection interval with the total forward (or backward) message delay. This combined approach, referred to as the dual-tuning technique, is illustrated in FIG. 18 for forward transmission. Its corresponding flowchart 1800 comprises eight major steps, as described below.
1) START 1801—The dual-tuning routine is launched for execution.
2) Set Transmission Power 1802—The transmission power is set to a high level to maximize the sig-nal-to-noise ratio, thereby minimizing channel errors during packet transmission.
3) Set Bit Pattern 1803—The synchronization message is configured to always contain the same bit pattern, ensuring that the routines at the receiver follow the same program execution path, thereby equalizing the decoding times of the received data packets in the packet train.
4) Coarse Tuning 1812-Determine the minimum value of the BLE connection interval, 7 such that the period of a train of data packets, whose value at the transmitter equals the BLE connection interval, does not exceed the BLE connection interval at the receiver due to the total forward message delay, δOv. This step consists of four substeps, as follows.
   4a) Substep 1804-Set the BLE connection interval to its maximum duration, which is 4 seconds as specified by the BLE standard.
   4b) Substep 1805-Check whether (i) the total forward message delay, δ_{FOV}, remains less than the BLE connection interval, T_{CI}; and (ii) the BLE connection interval, T_{CI}, is still greater than 7.5 milliseconds, which is the minimum value allowed by the BLE standard.
   4c) Substep 1806-If Yes, decrement the BII connection interval by 1.25 milliseconds, which is the minimum adjustment allowed by the BLE standard, and proceed to Substep 1805.
   4d) Substep 1807-If No, increment the BLE connection interval by 1.25 milliseconds, to restore its previous value, for which the total forward message delay, δ_{FOV} was still less than the BLE connection interval, ⁷ m, and continue with Fine Tuning 1813.
5) Fine Tuning 1813-Insert dummy operations into the program at the application layer 301 to artificially increase the total forward message delay, δ_{FOV}, so that it more closely matches the BLE connection interval. This step consists of two substeps, as detailed below.
   5a) Substep 1808-Increment the total forward message delay, δ_{FOV}, by the latency of a single dummy operation (or by a small number of dummy operations if faster tuning convergence is desired and reduced tuning accuracy is acceptable).
   5b) Substep 1809—-Check whether the total forward message delay, δ_{FOV} is still less than the BLE connection interval, Tc

If Yes, proceed to Step 1808 to further increase the total forward message delay, δ_{FOV}.

If No, continue with Timestamping 1814.
6) Timestamping 1814—A time-ordered set of timestamps is acquired at the transmitter, and another time-ordered set of timestamps is acquired at the receiver.
7) Digital Filtering 1810—The resulting timestamps at the receiver can be interpreted as forming a rectangular signal, whose fundamental frequency component has a period equal to the BLE connection interval, T_{CI}. By applying digital filtering, only the fundamental frequency component is retained, thereby reducing errors in matching the total message delay to the BLE connection interval,
8) END 1811—The dual-tuning routine is completing its execution.

It is important to note that the dual-tuning technique forces the BLE connection interval to iteratively converge toward the total message delay. This represents a significant improvement over the prior art, specifically the Gradient Time Synchronization Protocol discussed in the previous section (see FIG. 7), where the timestamp t approaches the interrupt generation time bᵢ only by chance, rather than by design. Regarding the coarse tuning phase 1812 and the fine tuning phase 1813, it should be noted that alternative incrementation and/or decrementation patterns may be employed to accelerate convergence during the tuning process. For instance, in the coarse tuning phase 1812, the BLE connection interval can be adjusted using a logarithmic pattern, for example, starting at 4 seconds, then reducing to 2 seconds, I second, and so on. A similar loganithiic or adaptive strategy can be applied in the fine tuning phase 1813 to incrementally increase the total message delay, thereby improving tuning efficiency.

FIG. 19 illustrates a train of packets transmitted over a BLE link in the forward direction, where the BLE connection interval period 1901, denoted as T_{CI}, has been tuned to match the total message processing (i.e., decoding) delay at the receiver 1902, given by δ_{FOV}-δ_{PROP}. Specifically, the Transmitted Data Packets T-Packet) 1909, 1910, and 1911, corresponding to the time-ordered set of timestamps

$${T}_{1 , device}^{′}$$

1903,

$${T}_{1 , device}^{″}$$

1904,

$${T}_{1 , device}^{″′}$$

and

$${T}_{2 , server}^{′}$$

1905, become the Received Data Packets (R-Packet) 1912, 1913 and 1914 which correspond to the time-ordered set of timestamps

$${T}_{2 , server}^{″}$$

1906

$${T}_{1 , server}^{″′}$$

1907 and 1908, Because the propagation delay. τ_{PROP}, is significantly smaller than the total forward message delay, δFOB, in all practical scenarios, the timestamps

$${T}_{1 , device}^{″}$$

1904 and

$${T}_{1 , device}^{″′}$$

1905 acquired on the client device. and

$${T}_{2 , server}^{′}$$

1906 and

$${T}_{2 , server}^{″}$$

1907 acquired on the time server become aligned. This scenario, where the total message processing (i.e., decoding) delay at the receiver approximately equals the total forward message delay 2004, as expressed in Equation 24:

$${δ}_{FOV} - {δ}_{PROP} \approx {δ}_{FOV} , \qquad ( 24 )$$

is illustrated in FIG. 20, where

$${T}_{1 , device}^{″}$$

1904 aligns with

$${T}_{2 , server}^{′}$$

2001,

$${T}_{1 , device}^{′′′}$$

1905 aligns with

$${T}_{2 , server}^{″}$$

2002, and so on. In the final phase, the time server returns the timestamp values

$${T}_{2 , server}^{′}$$

2001,

$${T}_{2 , server}^{″}$$

2002, and so on, to the client device for further processing. It is important to recall that the system time
on the client device is offset by a time difference, θ, while the time server's system time is assumed to be accurate and serves as the reference clock, As a result, the client device estimates and corrects its time offset as:

$$θ = {T}_{2 , server}^{′} - {T}_{1 , device}^{″} = {T}_{2 , server}^{″} - {T}_{1 , device}^{′′′} = \qquad ( 25 )$$

In FIG. 20, it is observed that the very first timestamp acquired on the client device

$${T}_{1 , device}^{′}$$

1903, and the very last timestamp acquired on the time server.

$${T}_{2 , server}^{′′′}$$

2003, are excluded from the time offset estimation, as neither forms part of a valid timestamp pair. These extraneous timestamps can be discarded either in hardware, for example by manipulating the FIFO stack 1202 or in software. For improved accuracy. it is also possible to compute the time offset, θ, by averaging multiple timestamp differences, That is,

$$θ = average ( {T}_{2 , server}^{′} - {T}_{1 , device}^{″} , {T}_{2 , server}^{″} - {T}_{1 , device}^{″′} , … ) \qquad ( 26 )$$

This averaging reduces the impact of jitter, noise, or occasional outliers in the timestamp measurements, thereby improving the robustness of the synchronization process.

It is also observed that similar results may be obtained when using an integer multiple, k, of the BLE connection interval, T_{CI}, as shown in Equation 27.

$${δ}_{FOV} = {δ}_{F} + {δ}_{OV} \approx k {T}_{CI} \qquad ( 27 )$$

This generalization allows for greater flexibility in matching the total forward or backward message delay, particularly in scenarios where higher resolution or extended measurement intervals are advantageous.

In yet another embodiment of the invention, the synchronization process is performed in the backward direction, wherein the total backward message delay, which includes the data encoding delay on the time server, is matched to the duration of the BLE connection interval, This approach may allow for higher tuning precision, as the time-consuming error correction is executed only after the timestamps have been captured by the IoT peripheral's hardware additions 1101, In this scenario, the train of data packets at the time server, which functions as the transmitter in this embodiment, is initially calibrated such that its period equals the BE connection interval, T_{CI}.

In still another embodiment of the invention, neither the client device nor the time server is capable of performing timestamping at a low layer of the BLE stack. In such cases, timestamping must instead be performed at the application layer on both devices. Consequently, the tuning process is governed by Equation 28, rather than Equation 23.

$${T}_{CI , min} = {min}_{{δ}_{FOV}^{′} \leq {T}_{CI}} {T}_{CI} , \qquad ( 28 )$$

where the total forward message delay, δ′_{FOV}, (or the backward message delay, δ′_{BOV}, if tuning is performed in the backward direction), also includes additional delays introduced by message processing within the client device, as shown in Equation 29. As a result, the accuracy of system clock synchronization is reduced due to the increased variability and non-determinism associated with higher-layer processing.

$${δ}_{FOV}^{′} = {\underbrace{( {τ}_{D , AL + HSP , F} + {τ}_{D , LL , F} + {τ}_{D , PHY , F} )}}_{Device Component} + {τ}_{PROP} + {\underbrace{( {τ}_{S , PHY , F} + {τ}_{S , LL , F} + {τ}_{S , AL + HSP , F} )}}_{Server Component} + {δ}_{OV} \qquad ( 29 )$$

$${δ}_{BOV}^{′} = {\underbrace{( {τ}_{D , AL + HSP , B} + {τ}_{D , LL , B} + {τ}_{D , PHY , B} )}}_{Device Component} + {τ}_{PROP} + {\underbrace{( {τ}_{S , PHY , B} + {τ}_{S , LL , B} + {τ}_{S , AL + HSP , B} )}}_{Server Component} + {δ}_{OV}$$

As a final comment, it should be noted that applying time offsets that move the system clock backward should be avoided, as they can lead to unintended side effects in running programs. Therefore, such backward adjustments should be limited to the initial system startup or reboot sequence, when no active processes depend on continuous forward progression of time.

What is claimed is:

1. A method for system clock synchronization of a client device with a time server, wherein the client device and the time server each comprise a Bluetooth Low Energy (BLE) module configured to establish a BLE link and to exchange data packets via said BLE link, the BLE link having (i) a configurable connection interval as defined by the BLE standard, and (ii) a data decoding latency determined by a specific BLE stack implementation on the time server. the method comprising:
a) equalizing the configurable connection interval of the BLE link with the data decoding latency of the BLE stack implementation on the time server;
b) acquiring a first time-ordered set of timestamps by timestamping the client device at its BLE physical layer during sending of a set of data packets;
c) acquiring a second time-ordered set of timestamps by timestamping the time server at its BLE application layer during reception of the set of data packets;
d) removing the first-acquired timestamp from the first time-ordered set of timestamps to produce a first reduced time-ordered set of timestamps;
e) removing the last—acquired timestamp from the second time—ordered set of timestamps to produce a second reduced time-ordered set of timestamps;
f) calculating a time-ordered set of timestamp differences by subtracting each timestamp in the first reduced time-ordered set of timestamps from the corresponding timestamp in the second reduced time-ordered set of timestamps;
g) calculating the average value of the timestamp differences in the time-ordered set of timestamps differences; and
h) using the average value to correct the system clock of the client device,
whereby synchronization of the system clock of the client device with the system clock of the time server is achieved.

2. The method of claim, wherein equalizing the configurable connection interval of the BLE link with the data decoding latency of the BLE stack implementation on the time server is achieved by:
a) transmitting a train of data packets with a period equal to the connection interval of the. BLE link; and
b) iteratively adjusting the connection interval—and thus the period of the train of data packets—until it becomes equal to the data decoding latency of the BLE stack implementation on the time server.

3. The method of claim, wherein the data decoding latency of the BLE stack implementation on the time server is configurable, and wherein equalizing the configurable connection interval of the BLE link with the data decoding latency of the BLE stack implementation on the time server is achieved by:
a) transmitting a train of data packets with a period equal to the connection interval of the BLE link; and
b) iteratively adjusting the data decoding latency of the BLE stack implementation on the time server until it becomes equal to the connection interval of the BLE link, and thus also to the period of the train of data packets.

4. The method of claim, wherein the data decoding latency of the BLE stack implementation on the time server is configurable, and wherein equalizing the configurable connection interval of the BLE link with the data decoding latency of the BLE stack implementation on the time server is achieved by:
a) transmitting a train of data packets with a period equal to the connection interval of the BLE link; and
b) iteratively adjusting both the connection interval of the BLE link-and thus the period of the train of data packets-and the data decoding latency of the BLE stack implementation on the time server until the two values become equal.

5. A method for system clock synchronization of a client device with a time server, wherein the client device and the time server each comprise a Bluetooth Low Energy (BLE) module configured to establish a BLE link and to exchange data packets via said BLE link, the BLE link having (i) a configurable connection interval as defined by the BLE standard, and (ii) a data encoding latency determined by a specific BLE stack implementation on the time server, the method comprising:
a) equalizing the configurable connection interval of the BLE link with the data encoding latency of the BLE stack implementation on the time server;
b) acquiring a first time-ordered set of timestamps by timestamping the time server at its BLE application layer during sending of a set of data packets;
c) acquiring a second time-ordered set of timestamps by timestamping the client device at its BLE physical layer during reception of the set of data packets;
d) removing the first-acquired timestamp from the first time-ordered set of timestamps to produce a first reduced time-ordered set of timestamps;
e) removing the last-acquired timestamp from the second time-ordered set of timestamps to produce a second reduced time-ordered set of timestamps;
f) calculating a time-ordered set of timestamp differences by subtracting each timestamp in the first reduced time-ordered set of timestamps from the corresponding timestamp in the second reduced time-ordered set of timestamps;
g) calculating the average value of the timestamp differences in the time-ordered set of timestamp differences; and
h) using the average value to correct the system clock of the client device,
whereby synchronization of the system clock of the client device with the system clock of the time server is achieved.

6. The method of claim 4, wherein equalizing the configurable connection interval of the BLE link with the data encoding latency of the BLE stack implementation on the time server is achieved by:
a) transmitting a train of data packets with a period equal to the connection interval of the BLE link; and
b) iteratively adjusting the connection interval—and thus the period of the train of data packets—until it becomes equal to the data encoding latency of the BLE stack implementation on the time server.

7. The method of claim 4, wherein the data encoding latency of the BLE stack implementation on the time server is configurable, and wherein equalizing the configurable connection interval of the BLE link with the data encoding latency of the BLE stack implementation on the time server is achieved by:
a) transmitting a train of data packets with a period equal to the connection interval of the BLE link; and
b) iteratively adjusting the data encoding latency of the BLE stack implementation on the time server until it becomes equal to the connection interval of the BLE link, and thus also to the period of the train data packets.

8. The method of claim 4, wherein the data encoding latency of the BLE stack implementation on the time server is configurable, and wherein equalizing the configurable connection interval of the BLE link with the data encoding latency of the BLE stack implementation on the time server is achieved by:
a) transmitting a train of data packets with a period equal to the connection interval of the BLE link; and
b) iteratively adjusting both the connection interval of the BLE link-and thus the period of the train of data packets-and the data encoding latency of the BLE stack implementation on the time server until the two values become equal.

9. A mechanism for system clock synchronization of a client device with a time server, wherein the client device and the time server each comprise a Bluetooth Low Energy (BLE) module configured to establish a BLE link and to exchange data packets via said BLE link, the BLE link having (i) a configurable connection interval as defined by the BLE standard, and (ii) a data processing latency determined by a specific BLE stack implementation on the time server, the mechanism comprising:
a) means for equalizing the connection interval of the BLEI link with the data processing latency of the BLE stack implementation on the time server;
b) means for timestamping the client device at its BLE physical layer, and means for storing a first time-ordered set of resulting timestamps;
c) means for timestamping the time server at its BLE application layer, and means for storing a second time-ordered set of resulting timestamps;
d) means for removing the first—acquired timestamp from the first time-ordered set of resulting timestamps to produce a first reduced time-ordered set of timestamps;
e) means for removing the last-acquired timestamp from the second time-ordered set of resulting timestamps to produce a second reduced time-ordered set of timestamps;
f) an arithmetic unit configured to calculate a time-ordered set of timestamp differences by subtracting each timestamp in the first reduced time-ordered set of timestamps from the corresponding timestamp in the second reduced time-ordered set of timestamps;
g) an averaging unit configured to calculate the average value of the timestamp differences in the time-ordered set of timestamp differences; and
h) a correction unit configured to adjust the system clock of the client device based on the calculated average value,
wherein the system clock of the client device is synchronized with the system clock of the time server.

10. A mechanism for system clock synchronization of a client device with a time server, wherein the client device and the time server each comprise a Bluetooth Low Energy (BLE) module configured to establish a BLEI link and to exchange data packets via said 131_B link, the BILE link having (i) a configurable connection interval as defined by the BLE standard, and (ii) a data processing latency determined by a particular BLE stack implementation on the time server, said mechanism comprising:
a) means for equalizing the connection interval of the BLE link with the data processing latency of the BLE stack implementation on the time server;
b) means for timestamping the client device at its BLE application layer, and means for storing a first time-ordered set of resulting timestamps;
c) means for timestamping the time server at its BLE application layer, and means for storing a second time-ordered set of resulting timestamps;
d) means for removing the first-acquired timestamp from the first time-ordered set of resulting timestamps to produce a first reduced time-ordered set of timestamps;
e) means for removing the last-acquired timestamp from the second time-ordered set of resulting timestamps to produce a second reduced time-ordered set of timestamps;
f) an arithmetic unit configured to calculate a time-ordered set of timestamp differences by subtracting each timestamp in the first reduced time-ordered set of timestamps from the corresponding timestamp in the second reduced time-ordered set of timestamps;
g) an averaging unit configured to calculate the average value of the timestamp differences in the time-ordered set of timestamp differences; and
h) a correcting unit configured to adjust the system clock of the client device based on the calculated average value,
wherein the system clock of the client device is synchronized with the system clock of the time server.
